(19) United States
(12) Patent Application Publication
(10) Pub. No.: US 2002/0108369 A1
(43) Pub. Date: Aug. 15, 2002

(54) Gravity-actuated motor apparatus

(76) Inventor: Richard Arel, Drummondville (CA)

Correspondence Address: Richard AREL, c/o PROTECTIONS EQUINOX INT'L INC., Suite 224, 4480, Cote-de-Liesse, Montreal, QC, H4N 2R1, CA

(21) Appl. No.: 10/073,279

(22) Filed: Feb. 13, 2002

(30) Foreign Application Priority Data
Feb. 12, 2001 (CA) 2,336,228
Feb. 13, 2001 (CA) 2,336,230
Feb. 13, 2001 (CA) 2,336,231
Feb. 13, 2001 (CA) 2,336,232
Feb. 13, 2001 (CA) 2,336,234
Jan. 7, 2002 (CA) 2,367,219

(51) Int. Cl. F16D 31/02

(52) U.S. Cl. 60/398

(57) ABSTRACT

A gravity-actuated motor apparatus (20) includes a frame (22) rotatably supporting a horizontal shaft (24) connected to a power generator (G). A plurality of circumferentially equally spaced apart elongated supports (30) extend radially away from and connect to the shaft (24). Each support (30) carries a weight (32) that radially moves relative to the shaft (24) along a closed path (33), thereby providing variable torque to the shaft (24) under gravity and induce its rotation. A track member (40) guides the displacement of the weights (32) relative to the shaft (24) along at least a tracking portion (41) of the closed path (33). The track member (40) is releasably engaged by the weights (32). An active guiding means (42) mounted on the track member (40) actively guides the weights (32) along the tracking portion (41) of the closed path (33). The weights (32) could also have a low density, such as floats (32f), and be displaced by buoyancy while being immersed within a denser soaking medium (26) inside an enclosure (23).

### FIELD OF THE INVENTION

The present invention relates to energy making devices and more particularly to a gravity-actuated motor apparatus for generating power from potential energy of weight objects.

### BACKGROUND OF THE INVENTION

Many devices and apparatuses have been developed in the past to generate power/energy by taking advantage of the gravity force and/or the buoyancy force to produce variable torque and induce rotation of a shaft.

U.S. Pat. No. 5,372,474 granted to Miller on Dec. 13, 1994 discloses an apparatus for gravity assisted rotational motion that includes a plurality of fixed hollow arms rotatably supported on an axle itself supported on a frame. A hollow reservoir is mounted at each outer end of each arm. Each reservoir can be selectively filled or emptied of a heavy flowable material such as water. Depending on the location of a reservoir around the axle, a heavy plate alternatively closes or opens the reservoir as the device rotates. The transfer of water form one end of each arm to the other end induces the rotational movement. Due to the fixed position of the arms relative to the axle, important counter torque is induced by the reservoirs and plates being raised. Furthermore, one cannot control the rotational speed of such an apparatus that remains generally constant, as opposed to vary between a maximum speed and zero speed with the device at rest.

PCT international application WO-99/37913 of Scibiorek published on Jul. 29, 1999 discloses an energy turbine for gravity assisted rotational motion that includes a plurality of arms rotatably supported on an axle itself supported on a frame. A weight is mounted at each outer end of each arm. Each arm can slide radially relative to the axle to vary the radial distance of each weight relative to the axle to generate a resulting torque that induces the rotational motion of the axle. A ratchet/latch mechanism allow for alternately locking the arm in two opposed extreme positions, depending on the location of a weight around the axle. The sliding of each arm induces the rotational movement. Here again, one cannot control the rotational speed of such an apparatus that remains generally constant.

Even though common rollers and bearings are used to reduce the friction, they seem not to be sufficient to prevent blocking when the weights displaced by the apparatus get relatively large. Accordingly, an active mechanism needs to be considered in helping at least over a portion of the overall displacement of the weights, which is lacking from the prior art.

U.S. Pat. No. 3,857,242 granted to Gilmore on Dec. 31, 1974; U.S. Pat. No. 3,934,964 granted to Diamond on Jan. 27, 1976; U.S. Pat. No. 4,326,132 granted to Bokel on Apr. 20, 1982; U.S. Pat. No. 4,718,232 granted to Willmouth on Jan. 12, 1988; U.S. Pat. No. 4,742,242 grarited to De Shon on May 3, 1988; and U.S. Pat. No. 5,944,480 granted to Forrest on Aug. 31, 1999 all disclose different turbines using the gravitational force and/or the buoyancy force with floating bodies secured to a chain and immersed into a fluid to induce the motion of the chain. The position of these bodies relative to the chain is fixed and do not allow for the torque to be alternately decreased and increased by the radial displacement of the bodies relative to the chain.

### SUMMARY OF THE INVENTION

It is therefore an object of the present invention to provide a gravity-actuated motor apparatus that obviates the above mentioned disadvantages.

An advantage of the present invention is that the gravity-actuated motor apparatus uses simple physics principles to generate power.

A further advantage of the present invention is that the gravity-actuated motor apparatus includes a track member that forces the displacement of the weights about a shaft such that they generate variable torques thereto.

Still another advantage of the present invention is that the gravity-actuated motor apparatus includes a track member that is displaceable to either vary the rotational speed of the weights around the shaft or allow for reverse rotation of the weights there around.

Still a further advantage of the present invention is that the gravity-actuated motor apparatus includes a track member with active weight displacement mechanism, preferably connected to the shaft.

Yet another advantage of the present invention is that the gravity-actuated motor apparatus includes variable speed system in the active weight displacement mechanism for accounting to the variable tangential speed of the weights around the shaft.

According to the present invention, there is provided a gravity-actuated motor apparatus for connecting to a power generator, the apparatus comprises:

a frame defining an enclosure;

a generally horizontal shaft defining a shaft axis, the shaft being freely rotatably supported by the frame for connection to the power generator;

a plurality of elongated supports extending substantially radially away from and connecting to the shaft, the supports being substantially circumferentially equally spaced apart from each other;

at least one weight member connecting to each one of the supports, the weight members have a first density and radially move relative to the shaft along a closed path, thereby providing variable torque thereto;

a track member guiding displacement of the weight members relative to the shaft along at least a tracking portion of the closed path, the track member being releasably engaged by the weight members;

an active guiding means for actively guiding the weight members along the tracking portion of the closed path, the active guiding means mounting on the track member; and

a soaking medium filling the enclosure to soak the shaft, supports and weight members therein, the soaking medium having a second density; whereby a difference between the first and second densities induces displacement of the weight members relative to the soaking medium within the enclosure under gravity so as to rotate the shaft connected to the power generator.

Preferably, the apparatus includes a track member positioning means for positioning the track member relative to the shaft, the track member positioning means defining a pivotal axis parallel to the shaft axis, the track member positioning means pivoting the track member about the pivotal axis.

Preferably, the active guiding means includes at least one speed adjusting means for adjusting the speed of the active guiding means to the varying speed of the weight members along the tracking portion of the closed path, the speed adjusting means successively guiding displacement of one of the weight members at a time.

Preferably, the speed adjusting means includes a weight member engaging means for releasably engaging the weight members to the speed adjusting means, a chain member connecting to the shaft, and a torsion spring connecting member for circumferentially and springingly connecting the weight member engaging means to the chain member.

Alternatively, the speed adjusting means includes a weight member engaging means for releasably engaging the weight members to the speed adjusting means, a hydraulic motor driving the weight member engaging means, and a hydraulic fluid pump connecting to the shaft and feeding the hydraulic motor.

Typically, each of the weight members includes a complementary track member engaging means for releasably engaging the weight member to the weight member engaging means, the weight member engaging means includes a cogwheel engaging the complementary track member engaging means.

Preferably, the weight member engaging means includes a flexible chain driven by cogwheel gear and engaging the complementary track member engaging means, and a flexible chain retaining means for retaining the flexible chain in engagement contact with the complementary track member engaging means, the flexible chain retaining means mounting on the track member. The flexible chain retaining means includes at least one spring biased roller resiliently biased to retain the flexible chain in engagement contact with the complementary track member engaging means, the flexible chain rollingly contacting the spring biased roller.

Preferably, the pivotal axis is co-linear with the shaft axis.

Typically, the track member includes a rail, each weight member includes at least one rod extending therefrom and slidably engages the rail.

Preferably, the first density is larger than the second density; whereby rotation of the shaft being induced by the torque provided by the weight members under gravity.

Preferably, each of the supports defines a support first end and an opposed support second end, the supports being axially spaced apart from each other along the shaft and freely radially sliding relative to the shaft between the support first and second ends, a first and a second of the weight members being fixedly connected to the support first and second ends, respectively, the track member radially displacing the weight members and the supports relative to the shaft.

Alternatively, each of the supports defines a support first end and an opposed support second end, the support first end attaching to the shaft, the weight members longitudinally sliding relative to the supports between the support first and second ends, the track member radially displacing the weight members relative to the supports and the shaft.

Alternatively, each of the weight members forms a closed shell defining a cavity therein, each of the cavity being partially filled with a fluid, the apparatus including a plurality of fluid channeling means for channeling the fluid between one of the cavities and an opposed of the cavities, thereby allowing for the fluid to freely flow therein between the opposed cavities.

Alternatively, each of the supports defines a through bore longitudinally extending between the support first and second ends, the through bore being in fluid communication with the cavities of the weight members of the support to form one of the fluid channeling means therebetween.

Preferably, the shaft defines a plurality of through bores, the through bores being diametrically oriented relative to the shaft, each of the through bores defining a bore axis and a bore inner surface, each of the through bores slidably receiving one of the supports therethrough. The shaft includes a plurality of roller bearings for rollably supporting each of the supports inside the through bores, each of the roller bearings movably mounting on the shaft for radial displacement relative thereto between a bearing first position wherein the support is substantially longitudinally aligned with the through bore axis and a bearing second position wherein the support is off-aligned from the through bore axis without abuttingly contacting the bore inner surface, and a bearing biasing means for biasing the roller bearings in the bearing first position.

Alternatively, the active guiding means includes:

a plurality of guiding teeth mounted on the track member, the guiding teeth being substantially equally spaced apart from each other along at least a portion of the closed path;

a pinion rotatably mounted on each of the weight members about an axis substantially parallel to the shaft axis for releasably meshing with the guiding teeth;

a pinion hydraulic pump mechanism connected to the pinion;

a pinion hydraulic motor connected to the pinion;

the pinion hydraulic pump mechanism of each of the pinions hydraulically interconnecting with a corresponding of the pinion hydraulic motors of another of the pinions so as to have the pinion hydraulic pump mechanism activated by the pinion of a first of the weight members engaging the guiding teeth under gravity hydraulically actuating the corresponding pinion hydraulic motor of a second of the weight members to activate the corresponding pinion also engaging the guiding teeth to actively raise the second weight member against gravity.

Alternatively, the active guiding means includes:

a plurality of fixed magnets mounted on the track member and being substantially equally spaced apart from each other along a magnet portion of the closed path, each of the fixed magnets being oriented so as to provide a maximal fixed magnetic field in a first substantially circumferential direction of the closed path, all of the fixed magnetic fields being of a first electrical polarity;

a mobile magnet mounted on each of the weight members, the mobile magnet being oriented so as to provide a maximal mobile magnetic field in a second substantially circumferential direction of the closed path when the weight members are adjacent the magnet portion of the closed path, the second circumferential direction being substantially in opposite direction relative to the first circumferential direction, all of the mobile magnetic fields being of a second electrical polarity, the mobile magnet magnetically interacting with the fixed magnets to induce displacement of the weight members relative to the track member along the closed path.

Preferably, at least a portion of the fixed magnets are fixed electromagnets, the fixed electromagnets being substantially equally spaced apart from each other along the magnet portion of the closed path, the active guiding means further includes:

an electrical power source connected to the fixed electromagnets;

an electromagnet controlling means for controlling the selective powering of the fixed electro-magnets when the mobile magnet of the weight members successively get into proximity to the fixed electromagnets, each of the fixed electromagnets providing a maximal fixed electromagnetic field in the first circumferential direction, the fixed electromagnetic fields being of the first electrical polarity.

Preferably, at least a portion of the mobile magnets are mobile electromagnets, the electrical power source being connected to the mobile electromagnets, the electromagnet controlling means further controlling the selective powering of the mobile electromagnets when the mobile electromagnets of the weight members successively get into proximity to the fixed magnets and the fixed electromagnets, each of the mobile electro-magnets providing a mobile maximal electromagnetic field in the second circumferential direction, the mobile electromagnetic fields being of the second electrical polarity.

Preferably, the electro-magnet controlling means includes switches mounted on the track member, each of the switches being electrically connected to a respective one of the fixed electromagnets and/or mobile electromagnets for operation thereof, the switches being selectively momentarily activated by the weight members so as to momentarily provide power to the respective fixed electromagnets and/or mobile electro-magnets when in proximity to a corresponding of the mobile magnets or mobile electro-magnets and/or a corresponding of the fixed magnets or fixed electromagnets, respectively.

Preferably, the first and second electrical polarities are of a common polarity, the first circumferential direction being substantially the direction of the displacement of the weight members relative to the closed path, each of the fixed magnets successively magnetically repulsing each of the mobile magnets.

Alternatively, the first and second electrical polarities are of opposed polarities, the second circumferential direction being substantially the direction of the displacement of the weight members relative to the closed path, each of the fixed magnets successively magnetically attracting each of the mobile magnets.

Alternatively, each of the pinions defines a plurality of pinion teeth, the active guiding means further includes:

a plurality of fixed magnets mounted on at least a portion of the guiding teeth and being substantially equally spaced apart from each other, each of the fixed magnets being oriented so as to provide a maximal fixed magnetic field in a first substantially circumferential direction of the closed path, all of the fixed magnetic fields being of a first electrical polarity;

a mobile magnet mounted on at least a portion of the pinion teeth of each of the pinions, each of the mobile magnets being oriented so as to provide a maximal mobile magnetic field in a second substantially circumferential direction of the closed path when the weight members are adjacent the closed path, the second circumferential direction being substantially in opposite direction relative to the first circumferential direction, all of the mobile magnetic fields being of a second electrical polarity, the mobile magnets magnetically interacting with the fixed magnets to induce displacement of the pinions relative to the guiding teeth and the weight members relative to the track member along the closed path.

Alternatively, the shaft defines a generally circular periphery;

each of the supports defining a support first end and an opposed support second end, the support first end pivotally connecting to the shaft periphery about a respective axis substantially parallel to the shaft so that the support pivots relative to the shaft periphery between a support retracted position with the support extending in a generally circumferential configuration relative to the shaft and a support extended position with the support extending in a generally radially outwardly configuration relative to the shaft, the supports being substantially circumferentially equally spaced apart from each other along the shaft periphery;

one of the weight members mounting on each of the support second ends to radially move relative to the shaft along a closed path, thereby providing variable torque thereto, the variable torque being larger the closer the support is to its support extended position.

Preferably, each of the supports includes an elongated support extension, the support extension defining an extension first end and an opposed extension second end, the extension first end pivotally connecting to the support second end about a respective axis substantially parallel to the shaft so that the support extension pivots relative to the support second end between a support extension retracted position with the support extension extending in a generally circumferential configuration relative to the shaft and a support extension extended position with the support extension extending in a generally radially outwardly configuration relative to the support second end and the shaft;

a second weight member mounting on each of the support extension second end to radially move relative to the shaft along a second closed path, thereby providing variable torque thereto, the variable torque being larger the closer the support extension is to its support extension extended position; and

the track member being releasably engaged by the second weight members, the track member guiding radial displacement of the second weight members relative to the shaft along at least a portion of the second closed path, the track member includes a second active guiding means for actively guiding the second weight members along the portion of the second closed path, the second active guiding means connecting to the shaft.

Preferably, the apparatus includes a plurality of first and second support abutting means located on the shaft adjacent the support first ends and on the support second ends adjacent the support extension first ends, respectively, each of the first support abutting means for abuttingly receiving the support first end thereon to retain the support in the support extended position against gravity, each of the second support abutting means for abuttingly receiving the support extension first end thereon to retain the support extension in the support extension extended position against gravity.

Preferably, each of the support second ends substantially abuts an adjacent of the supports adjacent the shaft periphery when the support is in the support retracted position under gravity, each of the support extension second ends substantially abuts an adjacent of the support extensions adjacent the shaft periphery when the support extension is in the support extension retracted position under gravity.

Preferably, each of the supports and support extensions substantially has a concave shape so as to substantially assume a portion of the shaft periphery when in the support retracted configuration and the extension retracted configuration, respectively.

Alternatively, the first density is smaller than the second density; whereby rotation of the shaft being induced by the torque provided by the weight members raising under buoyancy.

Typically, the track member is symmetrical relative to a symmetrical axis radially intersecting the shaft to allow for operation of the apparatus in both rotational directions about the shaft axis.

Preferably, each of the supports defines a support first end and an opposed support second end, the support first end attaching to the shaft, the weight members pivotally connecting to the support second ends about a respective axis substantially parallel to the shaft, the track member pivotally and radially displacing the weight members relative to the supports and the shaft, each of the support second end including a weight abutment means for retaining the weight member in a substantially radially and outwardly extending position relative to the support with the weight member being in a raising portion of the closed path.

Preferably, the weight abutment means is a support extension rigidly extending radially and outwardly from the support second end so as to abuttingly receive the weight member thereon.

Preferably, each of the weight members forms a closed shell being generally inflatable with a fluid between a deflated configuration and an inflated configuration, the apparatus including a plurality of fluid channeling means for channeling the fluid between one of the shells and an opposed of the shells, the track member including a shell deflating means for deflating one of the shells at a time along a deflating portion of the closed path so as to force the fluid to flow through the fluid channeling means between the opposed shells, each of the weight abutment means retains the weight member in a substantially radially and outwardly extending position relative to the support with the weight member being in a raising portion of the closed path in the inflated configuration.

Preferably, each of the supports defines a through bore extending between the support first and second ends, the through bore being in fluid communication with the shells of the weight members of the support to form one of the fluid channeling means therebetween.

Preferably, the fluid is of the first density, the fluid flowing along the through bores from one of the shells to the opposed one under operation of shell deflating means.

Other objects and advantages of the present invention will become apparent from a careful reading of the detailed description provided herein, within appropriate reference to the accompanying drawings.

### BRIEF DESCRIPTION OF THE DRAWINGS

In the annexed drawings, like reference characters indicate like elements throughout.

FIG. 1 is a section side view of an embodiment of a gravity-actuated motor apparatus in accordance with the present invention;

FIG. 2 is a partial longitudinal section view taken along line 2-2 of FIG. 1;

FIG. 3 is an enlarged partial section view, showing the details of the track member and the active guiding mechanism used to control and actively guide the displacement of the different weights;

FIG. 4 is a section view taken along line 4-4 of FIG. 3, showing some details of the preferred mechanical speed adjustment mechanism;

FIG. 5 is a section view taken along line 5-5 of FIG. 4;

FIG. 6 is an enlarged section view taken along line 6-6 of FIG. 1, showing some details of a preferred support sliding mechanism;

FIG. 7 is a section view taken along line 7-7 of FIG. 6;

FIG. 8 is a schematic view similar to FIG. 1, showing a second embodiment of a gravity-actuated motor apparatus in accordance with the present invention with a different active guiding mechanism;

FIG. 9 is a schematic view similar to FIG. 1, showing a third embodiment of a gravity-actuated motor apparatus in accordance with the present invention with a hydraulic-type active guiding mechanism;

FIG. 10 is a schematic view similar to FIG. 1, showing a fourth embodiment of a gravity-actuated motor apparatus in accordance with the present invention with fluid-weights alternating between two diametrically opposed cavities;

FIG. 11 is a schematic view similar to FIG. 1, showing a fifth embodiment of a gravity-actuated motor apparatus in accordance with the present invention with support sliding weights;

FIG. 12 is a schematic view similar to FIG. 1, showing a sixth embodiment of a gravity-actuated motor apparatus in accordance with the present invention with float-type weights soaking into a dense fluid;

FIGS. 13a to 13d are schematic views similar to FIG. 12, illustrating how the rotational speed of the apparatus can be controlled;

FIG. 14 is a schematic view similar to FIG. 11, showing a seventh embodiment of a gravity-actuated motor apparatus in accordance with the present invention with support sliding floats;

FIG. 15 is a schematic view similar to FIG. 12, showing an eighth embodiment of a gravity-actuated motor apparatus in accordance with the present invention with support pivotally connected floats;

FIG. 16 is a schematic view similar to FIG. 1, showing a ninth embodiment of a gravity-actuated motor apparatus in accordance with the present invention with a magnet/electro-magnet-activated guiding mechanism;

FIG. 17 is a schematic view similar to FIG. 16, showing a tenth embodiment of a gravity-actuated motor apparatus in accordance with the present invention with hydraulically-activated weight pinions guiding mechanism;

FIG. 17a is an enlarged partial view taken along line 17a-17a of FIG. 17, schematically showing the weight hydraulic mechanism;

FIG. 17b is an enlarged partial view taken along line 17b of FIG. 17; and

FIG. 18 is a schematic view similar to FIG. 1, showing an eleventh embodiment of a gravity-actuated motor apparatus in accordance with the present invention with circumferentially retractable weight supports.

### DETAILED DESCRIPTION OF THE PREFERRED EMBODIMENTS

With reference to the annexed drawings the preferred embodiments of the present invention will be herein described for indicative purpose and by no means as of limitation.

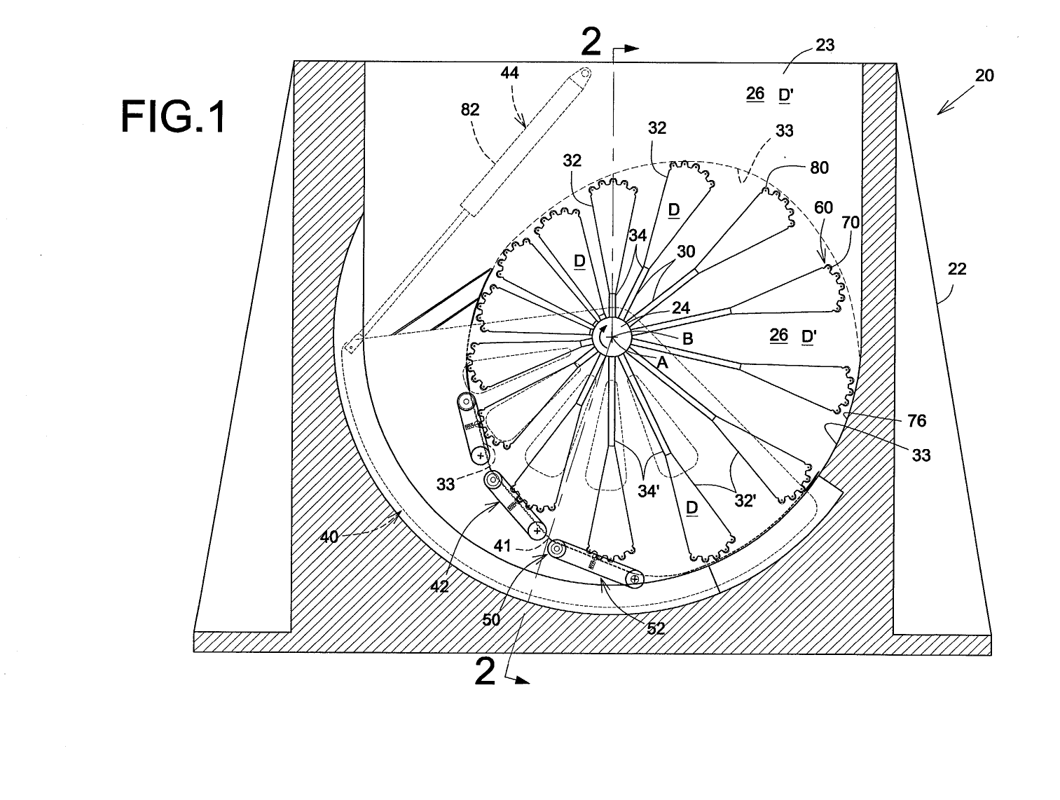

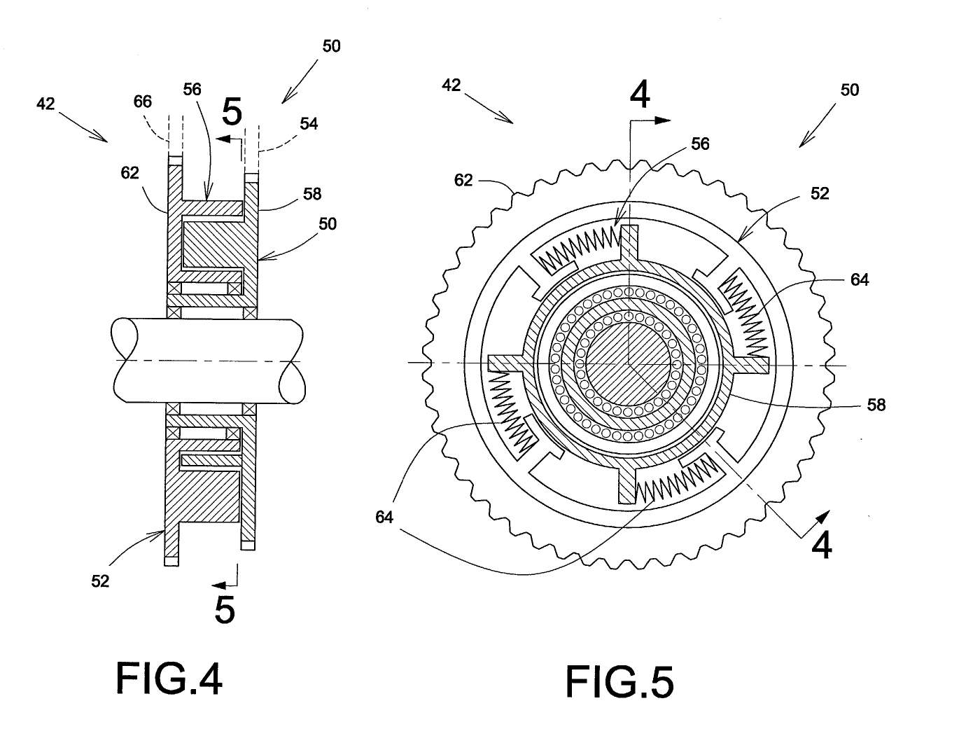

With reference to FIGS. 1 to 7, there is illustrated a first embodiment 20 of a gravity-actuated motor apparatus according to the present invention. The apparatus 20 generally connects to a power generator G and includes a frame 22 that defines an enclosure 23 with either an open or a closed top wall. A generally horizontal shaft 24 defines a shaft axis A, and is freely rotatably supported by the frame 22 and connected to the power generator G.

A plurality of elongated supports 30 extend substantially radially away from and connect to the shaft 24. The supports 30 are preferably substantially circumferentially equally spaced apart from each other, and each one 30 defines a support first end 34 and an opposed support second end 34′.

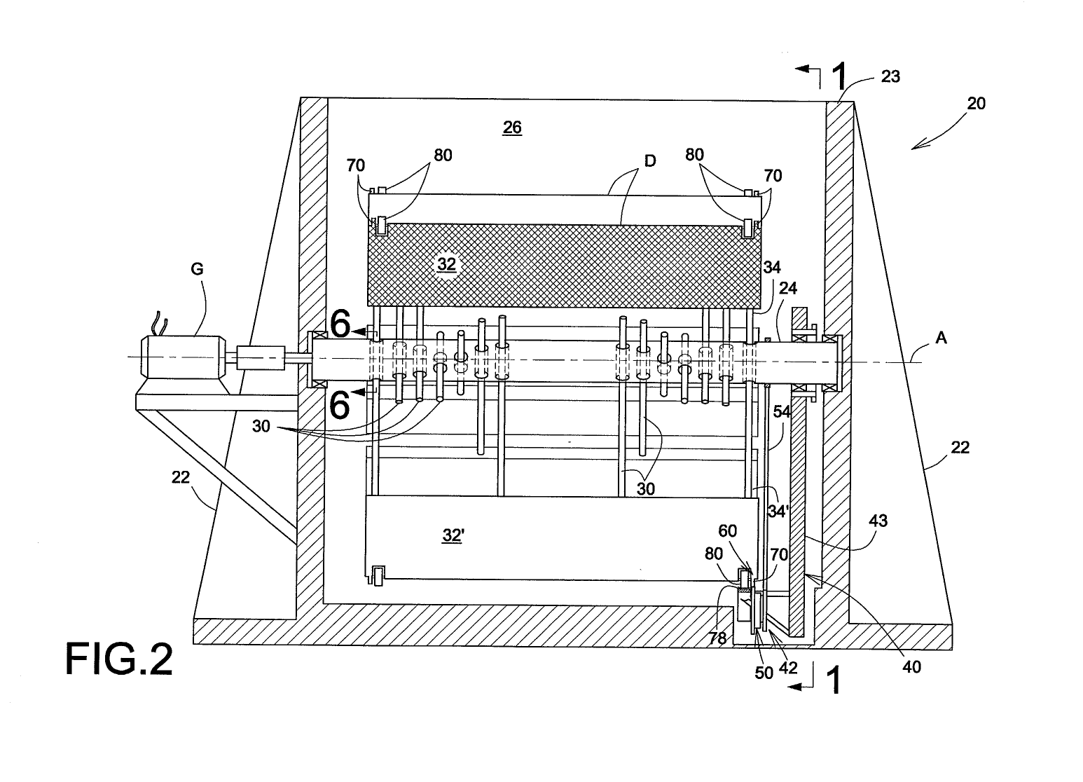

Opposed first 32 and second 32′ weight are connected to the support first 34 and second 34′ ends of each support 30, respectively. The weights 32,32′ have a first density D and radially move relative to the shaft 24 along a closed path 33 so as to provide variable torque to the shaft 24. Depending on the length of the weights 32,32′ in the direction of the shaft axis A, more that one support 30 could simultaneously and uniformly support each weight 32,32′, as shown in FIG. 2.

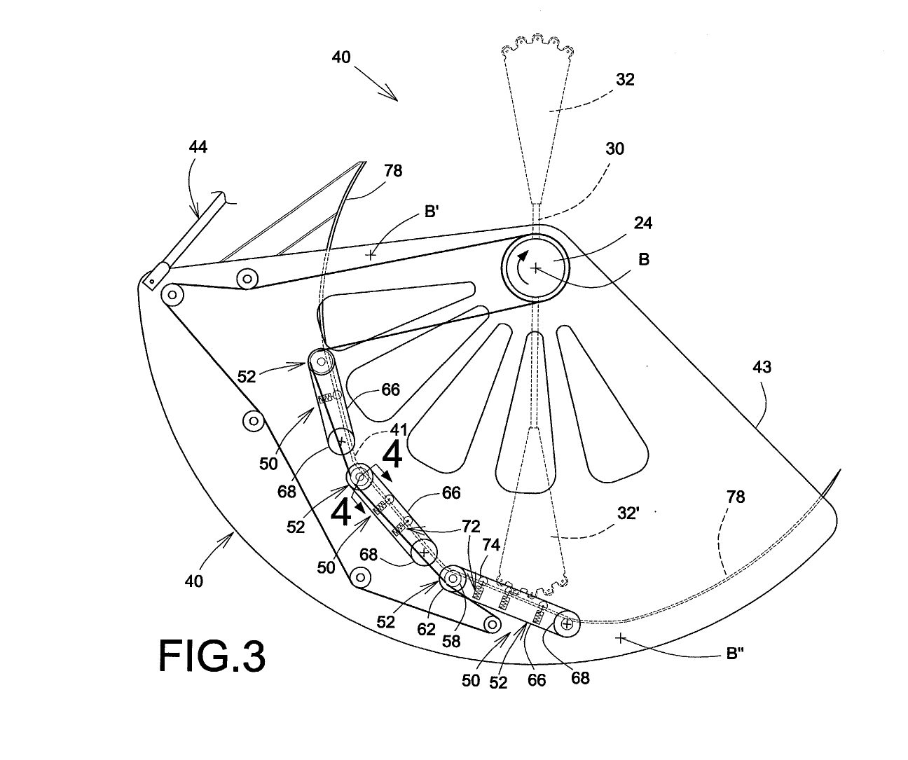

A track member 40 (shown in dotted lines in FIG. 1 for clarity purpose only) engaged by the first 32 and second 32′ weights guides their displacement relative to the shaft 24, along at least a tracking portion 41 of the closed path 33 called the “lifting” portion in which the weights 32,32′ are essentially pushed upwardly against gravity. A track member positioning means 44 is preferably used to position the track member 40 relative to the shaft 24 and to the frame 22 by pivoting the track member 40. The track member positioning means 44 for preferably pivotally positioning the track member 40 relative to the shaft 24 defines a pivotal axis B, parallel to and preferably co-linear to the shaft axis A, to pivot the track member 40 thereabout. Alternatively, the pivotal axis B of a modified track member 40 (not shown) could be located at other locations such as at B′ or even B″ shown in FIG. 3.

An active guiding means 42 for actively guiding the weights 32,32′ along the tracking portion 41 of the closed path 33 thereof is preferably connected to the shaft 24, as better shown in FIG. 3.

A soaking medium 26 fills the enclosure 23 as to soak the shaft 24, the supports 30 and the weights 32,32′ therein. The soaking medium 26 has a second density D′ such that a difference between the first D and second D′ densities induces the displacement of the weights 32,32′ relative to the soaking medium 26 within the enclosure 23 under gravity and/or buoyancy, so as to rotate the shaft 24 connected to the power generator G. In the embodiment 20 shown in FIGS. 1 to 7, the first density D of the relatively heavy weights 32,32′ is much larger than the second density D′ of the soaking medium 26 such as air or the like. Accordingly, the rotation of the shaft 24 is induced by the torque provided by the weights 32,32′ under gravity.

Although not specifically described herein, the use of ball bearings (not shown) and the like is preferable wherever applicable to reduce friction losses between parts in moving contact relative to each other. Referring to FIG. 3, the active guiding means 42 is preferably directly connected to the shaft 24 in order to use part of the generated power. In this case, it would be obvious to one skilled in the art to include a well known clutch mechanism (not shown) to enable a mechanical connect/disconnect between the active guiding means 42 and the shaft 24. Alternatively, whenever more practical when dealing with electrical or hydraulic types of energy, the active guiding means 42 could have its own power source, from outside the apparatus 20.

The active guiding means 42 preferably includes speed adjusting means 50 for continuously adjusting the speed of the lafter 50 to the constantly varying speeds of the weights 32,32′ along the tracking, or lifting, portion 41 of the closed path 33. The speed adjusting means 50 successively guide the displacements of one of the weights 32,32′ at a time since all of the weights 32,32′ in the tracking portion 41 of the closed path 33 have different speeds at any given time.

Referring to FIG. 2, although the tracking member 40 with the active guiding means 42 and the speed adjusting means 50 are shown to be only on the right-hand-side of the weights 32,32′, they could have their respective counterparts simultaneously mounted on the left-hand-side thereof to uniformly guide the weights 32,32′ along their length to smooth off their displacements.

Now referring more specifically to FIG. 3 and 5, each speed adjusting means 50 includes a weight engaging means 52 to directly and successively releasably engage the weights 32,32′ to the speed adjusting means 50, one at a time as in the embodiment 20 illustrated in FIG. 1. The weight engaging means 52 connects to a chain member 54, itself preferably linked to the shaft 24, via a torsion spring connecting member 56 that can circumferentially and springingly adapt to a gradually decreasing slight difference in rotational speed between the two, naming the weight member engaging means 52 and the chain member 54.

Accordingly, each of the weights 32,32′ includes a complementary track member engaging means 60 for them 32,32′ to properly and successively releasably engage each weight engaging means 52.

As illustrated in solid lines FIG. 3 and in phantom lines (for clarity purpose only) in FIG. 1, the active guiding means 42 preferably includes a support structure 43 rotatably mounted on the shaft 24 and supporting a plurality of speed adjusting means 50 thereon.

As shown in FIGS. 3 to 5, the weight engaging means 52 of each speed adjusting means 50 preferably includes a driving wheel 58 connected to a cogwheel 62 via the torsion spring connecting member 56; the latter 56 being composed of a plurality of circumferentially positioned helicoidal springs 64 properly sized to allow for a certain gradual “sliding” between the two due to the gradually decreasing rotational speed of the cogwheel 62 relative to the driving wheel 58 upon upward displacement of the driven weight 32,32′. During the gradual decreasing of the speed of the driven weight 32, the springs 64 are gradually or progressively compressed. Each cogwheel 62 drives a flexible chain 66 or the like (pictorially represented as strap for clarity purpose only). The latter 66 is also mounted on a respective free rotating gear 68 secured to the support structure 43, and is adapted to be engaged by the complementary track member engaging means 60, preferably made out of complementary teeth 70 or the like protrusions secured to each weight 32,32′. When a given weight 32 leaves the flexible chain 66, the compressed springs 64 force the cogwheel 62 to spin back and abut the driving wheel 58 as in the configuration illustrated in FIG. 5 until a next weight 32 engages the flexible chain 66.

Each chain member 54 of the speed adjusting means 50 is preferably a standard chain or the like, that links the driving wheel 58 to the shaft 24. In FIG. 3, the chain member 54 is common to all the driving wheels 58 of the different speed adjusting means 50, meshing with the specific size of each driving wheel 58 based on the actual required specific maximum speed thereof. Although not specifically shown, each speed adjusting means 50 could have its own independent chain member 54, either connected to the shaft 24 or to an equivalent external power source such as a conventional electrical motor or the like without departing from the scope of the present invention.

Typically, the weight member engaging means 52 further includes a flexible chain retaining means 72, preferably mounted on the track member 40, for retaining the flexible chain 66 in engagement contact with the complementary teeth 70 of the weight members 32,32′. Each flexible chain retaining means 72 preferably includes at least one spring biased roller 74 resiliently biased to retain the flexible chain 66 in engagement contact with the complementary teeth 70. The flexible chain 66 rollingly contacts the spring biased roller 74.

As better illustrated, in FIGS. 1 and 2, the supports 30 of the first embodiment 20 are preferably axially spaced apart from each other along the shaft 24 and freely radially slide relative to the shaft 24 between the two shaft ends 34,34′. The first 32 and opposed second 32′ weights are fixedly connected to the support first 34 and second 34′ ends, respectively. The track member 40, preferably partially consisting of the inner peripheral wall 76 of the enclosure 23 and partially of an auxiliary track 78 on the support structure 43, radially displaces the weights 32,32′ and the supports 30 relative to the shaft 24. In order for the weights 32,32′ to freely follow the inner peripheral wall 76, the weights 32,32′ preferably include weight rollers 80 or the like extending radially outwardly therefrom to rollingly engage the peripheral wall 76. The tracking portion 41 of the closed path 33 substantially covers most of the auxiliary track 78 section of the track member 40. To avoid heavy forces to impinge on the active guiding means 50 when the weight teeth 70 engage the weight engaging means 52 for 21 the weight traction, the weights 32,32′ are essentially supported by the weight rollers 80 rollingly engaging the auxiliary track 78.

As shown in FIGS. 2 and 3, the track positioning means 44 is preferably a double actuated hydraulic ram 82 having a first end pivotally attached to the frame 22 and a second end pivotally attached to the support structure 43. The support structure 43 is pivoted to a desired position relative to the shaft 24 about the pivotal axis B using the hydraulic ram 82. The pivotal axis B is preferably co-linear to the shaft axis A. By pivoting the support structure 43 around the shaft 24 to change the position of the track member 40 and the active guiding means 50, the rotational speed of the apparatus 20 is correspondingly affected, up to a position where the apparatus 20 stops rotating. Although the hydraulic ram 82 could be powered by a hydraulic pump (not shown) itself connected to the shaft 24, the hydraulic pump is preferably powered by an external power source.

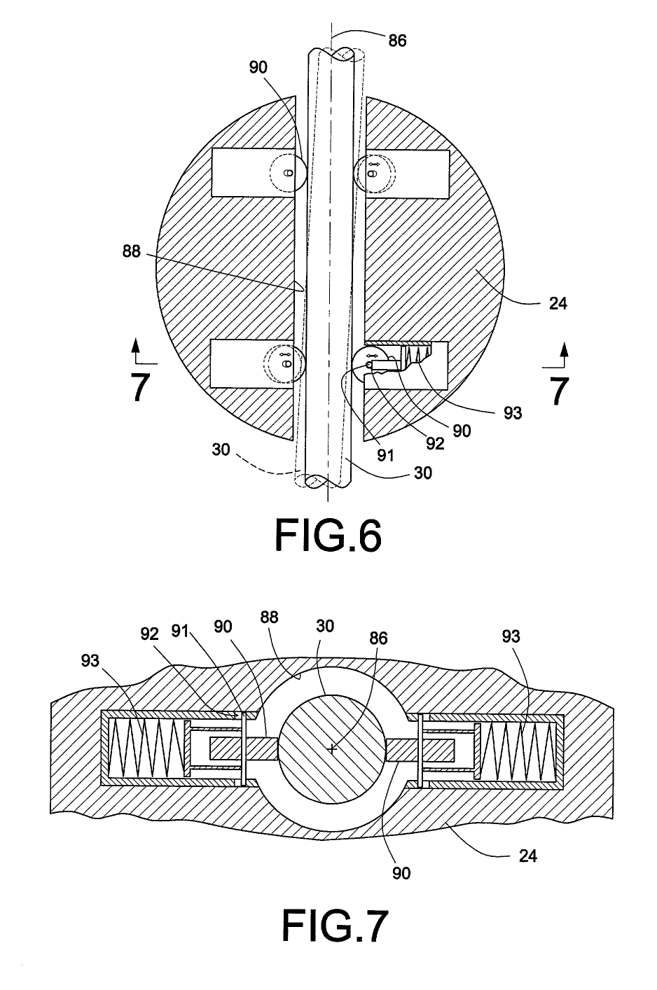

As illustrated more specifically in FIGS. 6 and 7, the shaft 24 defines a plurality of through bores 84, preferably of cylindrical shape, slidably receiving the supports 30 therethrough. Each through bore 84 is diametrically oriented relative to the shaft 24, and defines a bore axis 86 and a bore inner surface 88.

Preferably, the shaft 24 further includes a plurality of roller bearings 90 to rollably support each support 30 inside a corresponding through bore 84. Each roller bearing 90 movably mounts on the shaft 24 for radial displacement relative thereto in a plane defined by the closed path 33, between a bearing first position wherein the support 30 is substantially longitudinally aligned with the through bore axis 86, as shown in full lines in FIG. 6, and a bearing second position wherein the support 30 is off-aligned from the through bore axis 86 without abuttingly contacting the bore inner surface 88, as shown in dotted lines in FIG. 6. The bearing first and second positions are limited by the shaft 91 of the roller bearings sliding within corresponding slot holes 92. Each roller bearing 90 is biased in the bearing first position by a bearing biasing means 93, preferably a compression spring.

It is to be noted that throughout the following description, similar references terminating by a letter refer to similar parts of a different embodiment of the present invention, except wherever specifically mentioned.

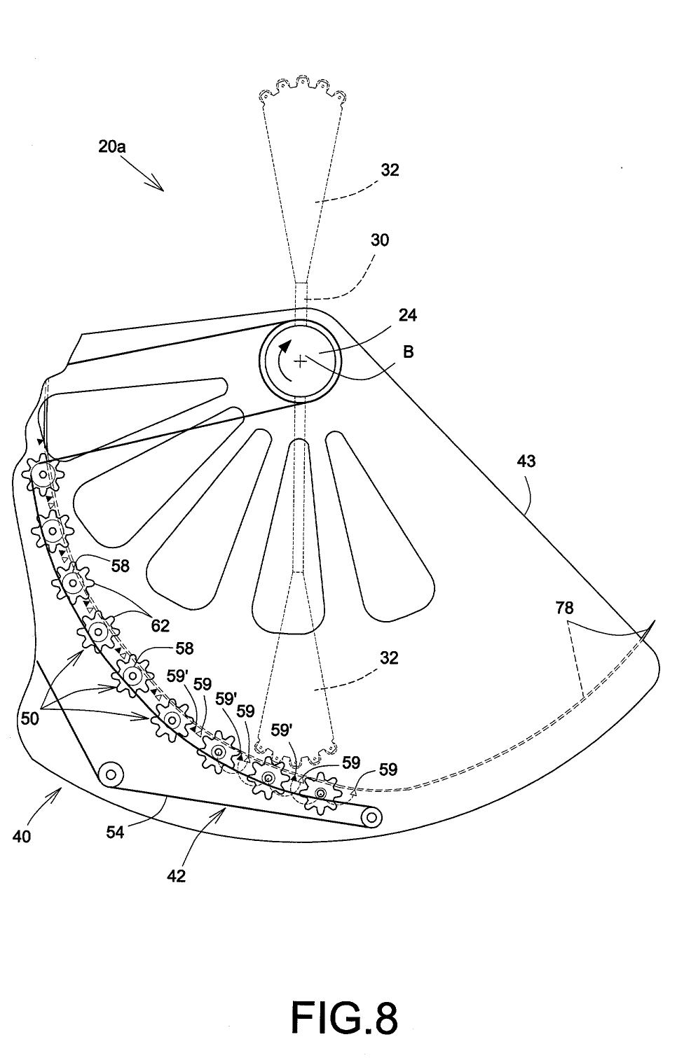

Alternatively, instead of having a few speed adjusting means 50 with each one engaging a specific weight 32 over a certain distance along its respective flexible chain 66, more speed adjusting means 50 could be adjacently located relative to each other. Each cogwheel 62 successively, releasably directly engages the different weights 32,32′ (without any flexible chain 66) as in the second embodiment 20a of a gravity-actuated motor apparatus according to the present invention illustrated in FIG. 8. In order to minimize the loss of energy, whenever a cogwheel 62 is not being used, such as between two successive weights 32,32′, its corresponding driving wheel 58 could be momentarily disengaged from the chain member 54. Accordingly, for each driving wheel 58, a corresponding turn-on switch 59 is activated by the weight 32,32′ about to reach the cogwheel 62 and a corresponding turn-off switch 59′ is activated by the weight 32 just after leaving the cogwheel 62. The switches 59,59′ are shown on FIG. 8 only for the first cogwheels 62 for clarity purposes. Each pair of switches 59,59′ is linked to a same speed adjusting means 50 (the links are schematically illustrated on FIG. 8 by dotted lines) via a clutch-type mechanism (not shown) or the like to control the engagement of the speed adjustment means 50 to the chain member 54.

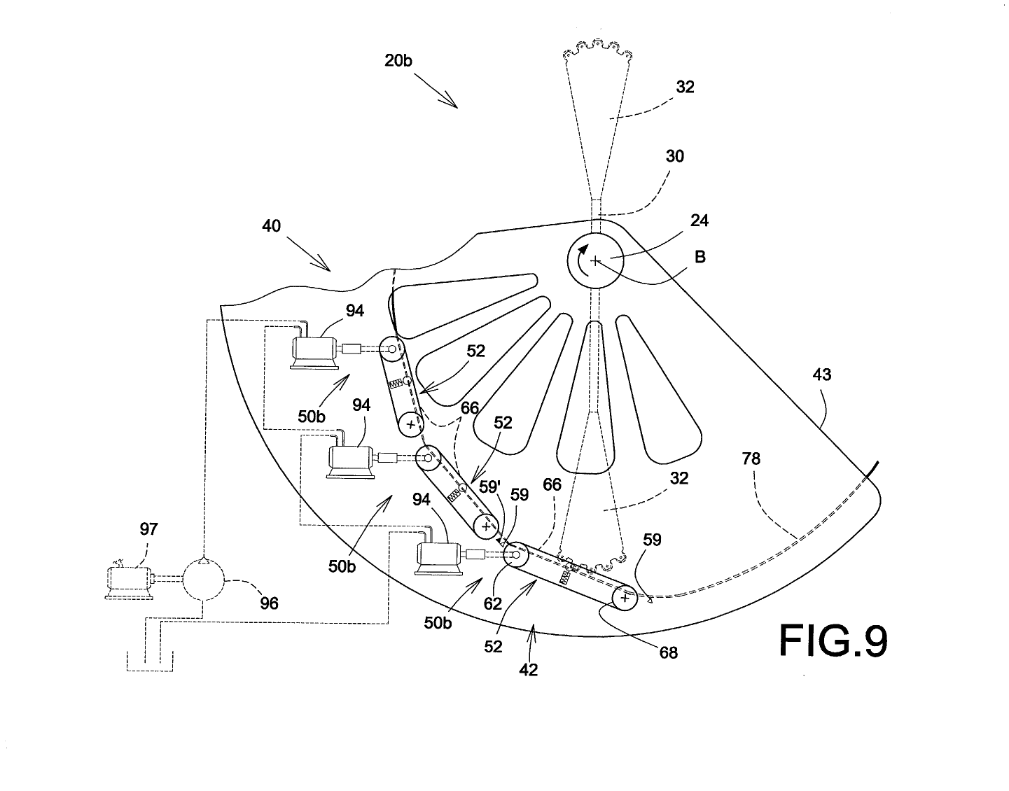

Instead of being purely mechanical-type as illustrated hereinabove, the speed adjusting means 50b could be hydraulic as schematically illustrated in the third embodiment 20b of a gravity-actuated motor apparatus according to the present invention shown in FIG. 9. Accordingly, each speed adjusting means 50b includes a hydraulic motor 94 to drive a corresponding cogwheel 62, and a hydraulic fluid pump 96, powered either by the shaft 24 or by any other external power source 97, that feeds the hydraulic motor 94. Each hydraulic motor 94, having its “sliding” capability selected over a certain speed range, is obviously properly sized to adapt to the varying speed of the weights 32,32′ they successively momentarily drive. Preferably, as shown in dotted lines for clarity purpose only, the same hydraulic fluid activated by a common pump 96 flows successively to the different hydraulic motors 94, the latter 94 being carried by the support structure 43.

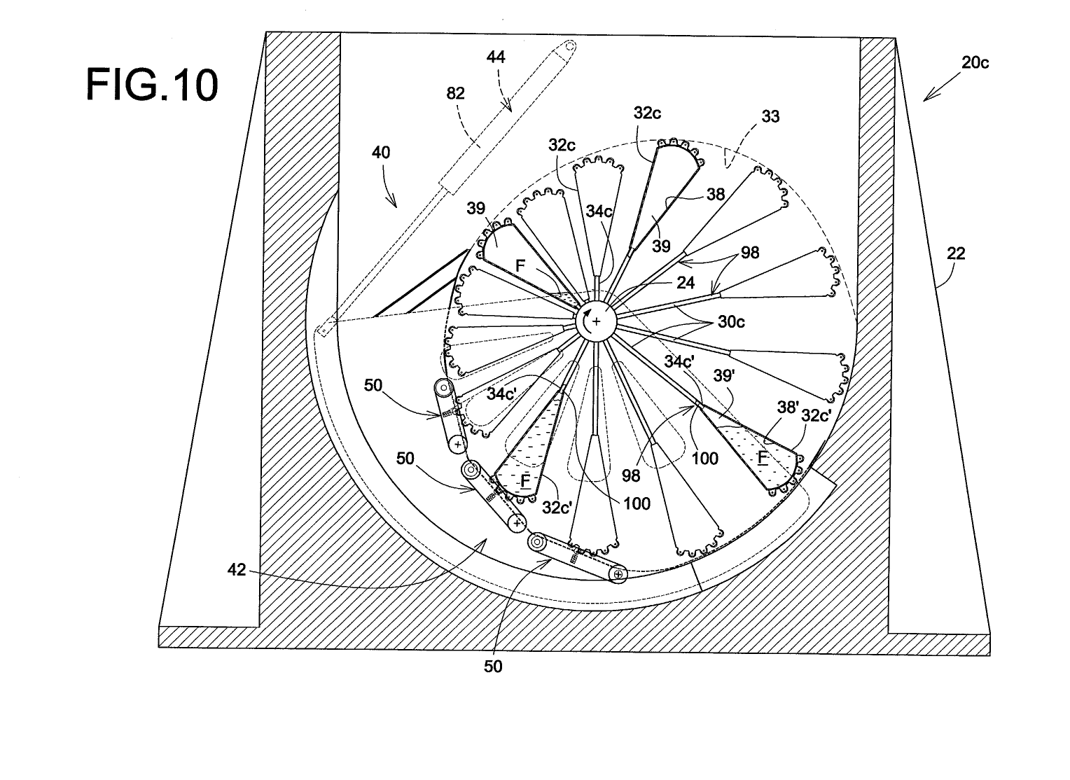

A fourth embodiment 20c of a gravity-actuated motor apparatus according to the present invention is partially schematically represented in FIG. 10. Each of the weights 32c,32c′ of the apparatus 20c forms a closed shell 38,38′ defining a cavity 39,39′ therein. Each cavity 39,39′ is partially filled with a fluid F of density D, preferably substantially dense liquid. The apparatus 20c includes a plurality of fluid channeling means 98 to channel the fluid F between one of the cavities 39 and the corresponding opposed cavity 39′. The fluid channeling means 98 is in fluid communication with the cavities 39,39′ of the opposed weights 32c,32c′ to allow for the fluid F to freely flow therein between the two under gravity. 24

Preferably, each support 30c defines a longitudinal through bore 100 extending between the support first 34c and second 34c′ ends that forms one of the fluid channeling means 98 between the two opposed cavities 39,39′.

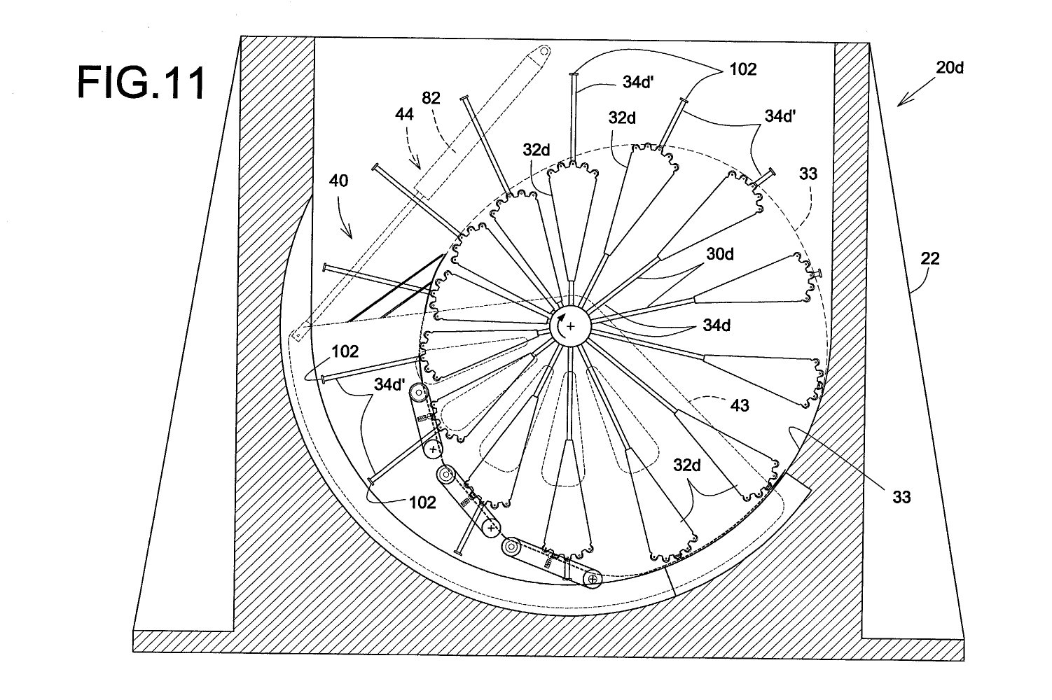

FIG. 11 partially shows a fifth embodiment 20d of a gravity-actuated motor apparatus according to the present invention in which the weights 32d longitudinally slide relative to the supports 30d, between the support first end 34d fixed relative to the shaft 24d and the support second end 34d′. The latter 34d′ preferably includes a weight stop 102 to prevent the weights 32d to slide off the supports 30d, as a safety feature. Accordingly, the track member 40d radially displaces the weights 32d relative to the supports 30d and the shaft 24d.

Although all the above embodiments 20 to 20d illustrate apparatuses with the weights 32,32′ being generally relatively heavy to induce an overall significant torque to the shaft 24 because of their variable radial positions relative thereto. Alternatively, similar apparatuses can be made with the first density D being smaller than the second density D′. The weights 32 are thereby be considered as floats 32 made out of low density materials or the like, or gas-filled type shells 38, with the soaking medium 26 being a relatively dense fluid medium such as water, oil and the like. The floats 32 would tend to raise under buoyancy, and the variable torque provided by the variable radial distances between each float 32 and the shaft 24 would induce the overall torque needed to rotate the shaft 24 and generate power through the power generator G. In order to reduce the drag force due to the displacement of the fluid medium 26 induced by the displacement of the floats 32f, the lafter preferably have a hydrodynamic external shape with a substantially low drag coefficient. This aspect has a very negligible impact on the previous embodiments 20 to 20d wherein the soaking medium 26 is a gas-type fluid, and no impact if the pressure level inside the enclosure 23 pressure is essentially null, close to full vacuum.

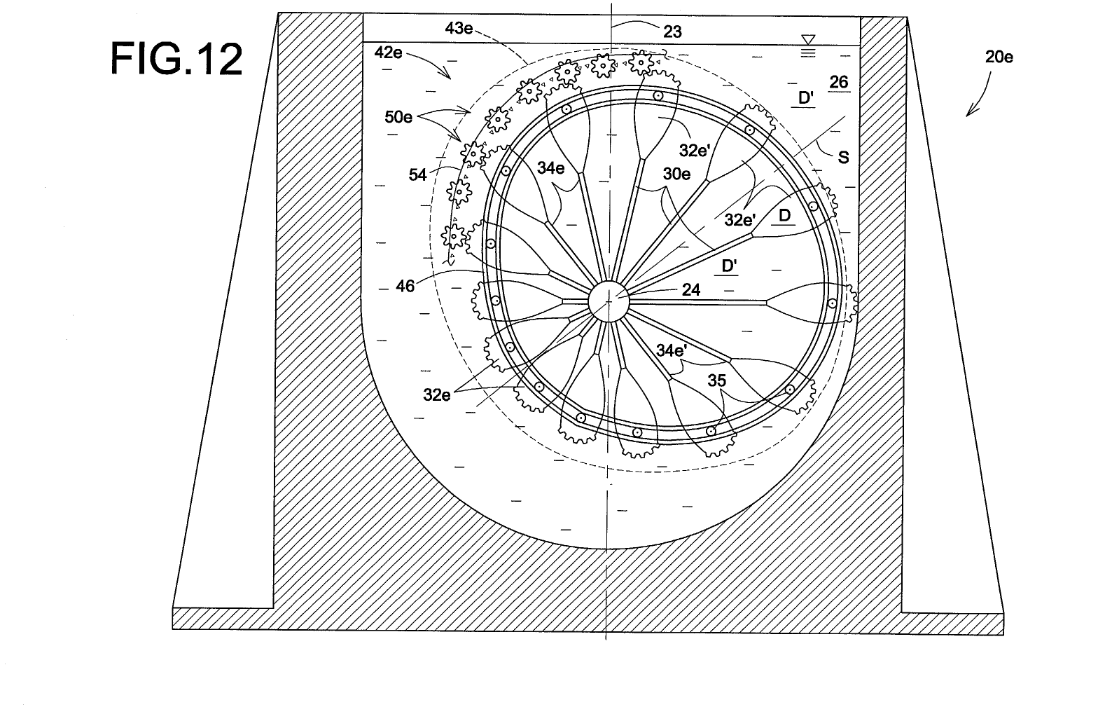

Referring to FIG. 12, there is shown a sixth embodiment 20e of a gravity-actuated motor apparatus according to the present invention. More specifically, this embodiment 20e is very similar to the first embodiment 20 with the difference that the floats 32e,32e′ secured to the support ends 34e,34e′ are preferably shaped so as to reduce the drag induced by its displacement within the fluid of the soaking medium 26. Also, the track member 40e is essentially used to guide the floats 32e,32e′ down against the buoyancy force while sliding the supports 30f radially into the through bores 84 of the shaft 24.

The track member 40e preferably includes a rail 46 adapted to be slidably engaged by rods 35 extending outwardly and axially from each float 32e,32e′. The rail 46 supported by the support structure 43e is substantially equivalent to both the inner peripheral wall 76 and the auxiliary shaft 78 of the embodiment 20 of FIG. 1. The rods 35 are preferably free to rotate about their respective axis to rollingly engage the rail 46 similarly than the weight rollers 80 of the embodiment 20 engage the inner peripheral wall 76 and the auxiliary track 78. The rail 46 is preferably symmetrical relative to an axis S radially intersecting the shaft 24. This symmetry of the rail 46 allows for operation of the apparatus 20f in both rotational directions about the shaft axis A, and for variation of the rotational speed of the shaft 24, thus the power generated by the apparatus 20e.

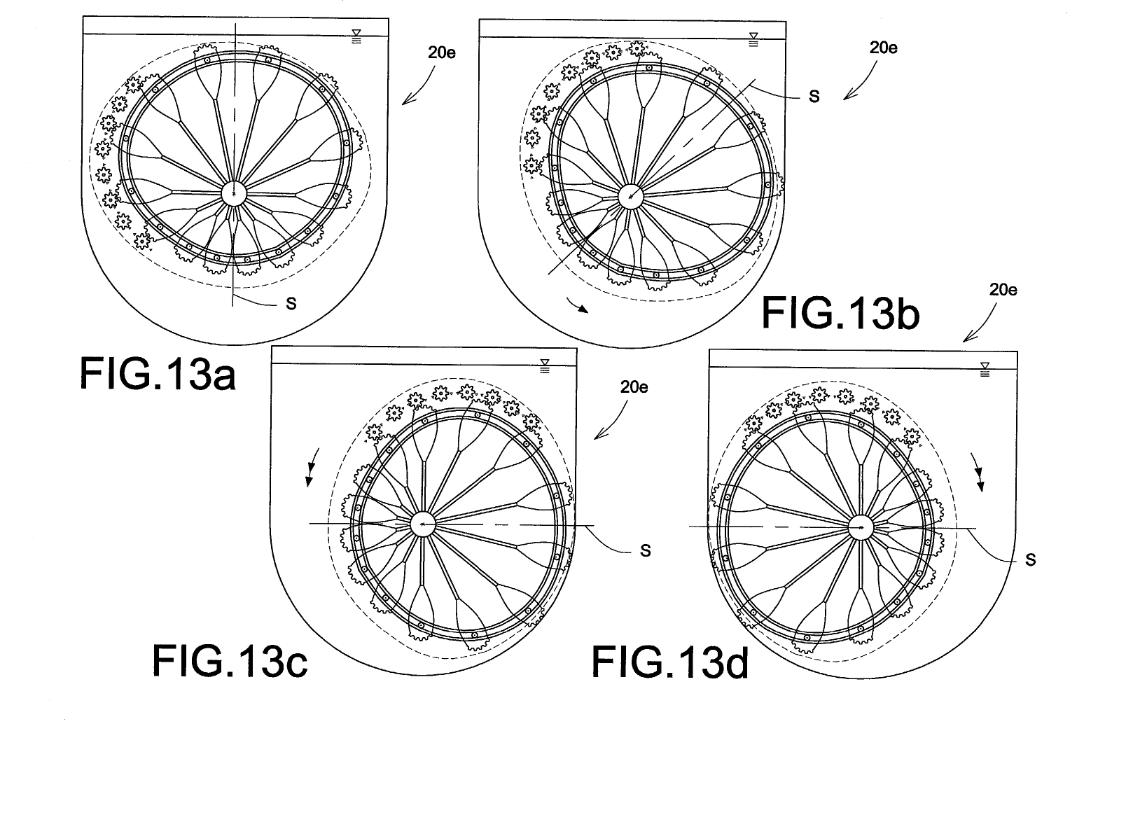

Accordingly, FIGS. 13a to 13d schematically illustrate the effect of the different positions of the track member 40e in which the rotational speed of the apparatus 20e is null (apparatus 20e is actually stopped with the weights 32e,32e′ equally distributed on each side of a vertical axis intersecting the shaft axis A), average in a first direction, maximum in the first direction, and maximum in the second direction, respectively. It is to be noted that in order to reverse the rotational direction of the apparatus 20e, a second active guiding means 42e′ is located opposite to the first active guiding means 42e relating to the symmetrical axis S. Obviously, either the first 42e or the second 42e′ active guiding means is operating at a time, while the other one is temporarily deactivated, using a clutch mechanism (not shown) or the like.

As opposed to the active guiding means 42 of the embodiment 20 of FIG. 1 used to lift the weights 32,32′ up against gravity and radially towards the shaft 24, the active guiding means 42e of the embodiment 20e of FIG. 12 pushes the weights 32e,32e′ down against buoyancy force and radially towards the shaft 24 using its speed adjustment means 50e.

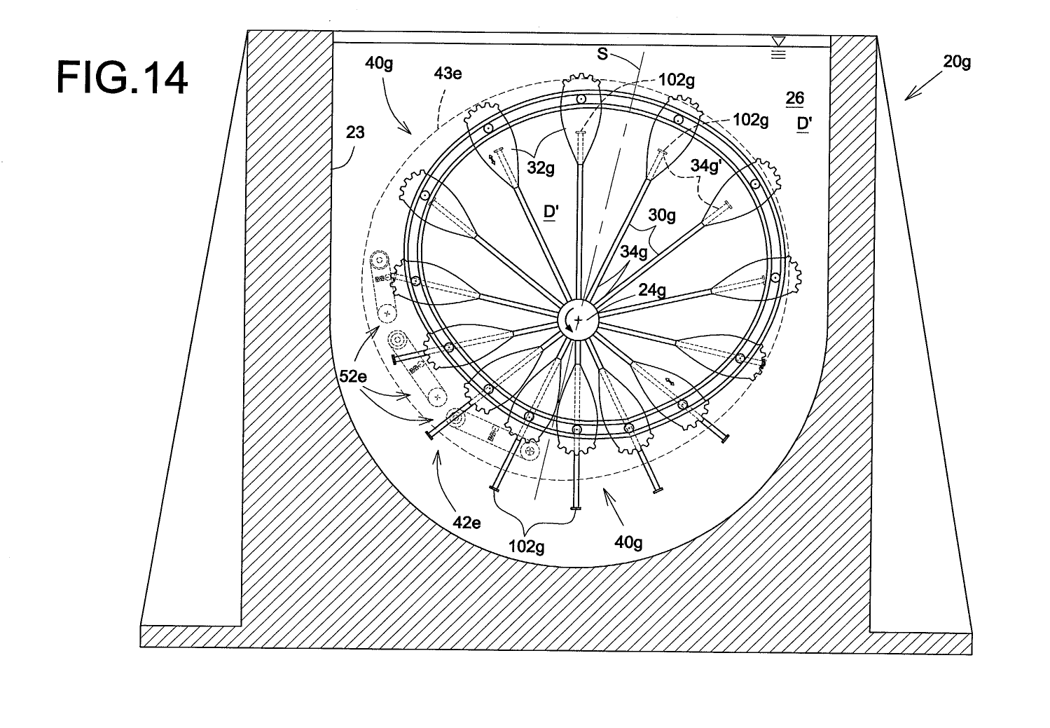

A seventh embodiment 20g of a gravity-actuated motor apparatus according to the present invention as illustrated in FIG. 14 is substantially similar to the embodiment 20d of FIG. 11. Each support 30g defines a support first end 34g and an opposed support second end 34g′ between which the float 32g longitudinally slides relative to the support 30g. The support first end 34g attaches to the shaft 24g and the support second end 34g′ preferably includes a weight stop 102g to prevent the float 32g to slide off the support 30g. Accordingly, the track member 40g radially displaces the floats 32g relative to the supports 30g and the shaft 24g.

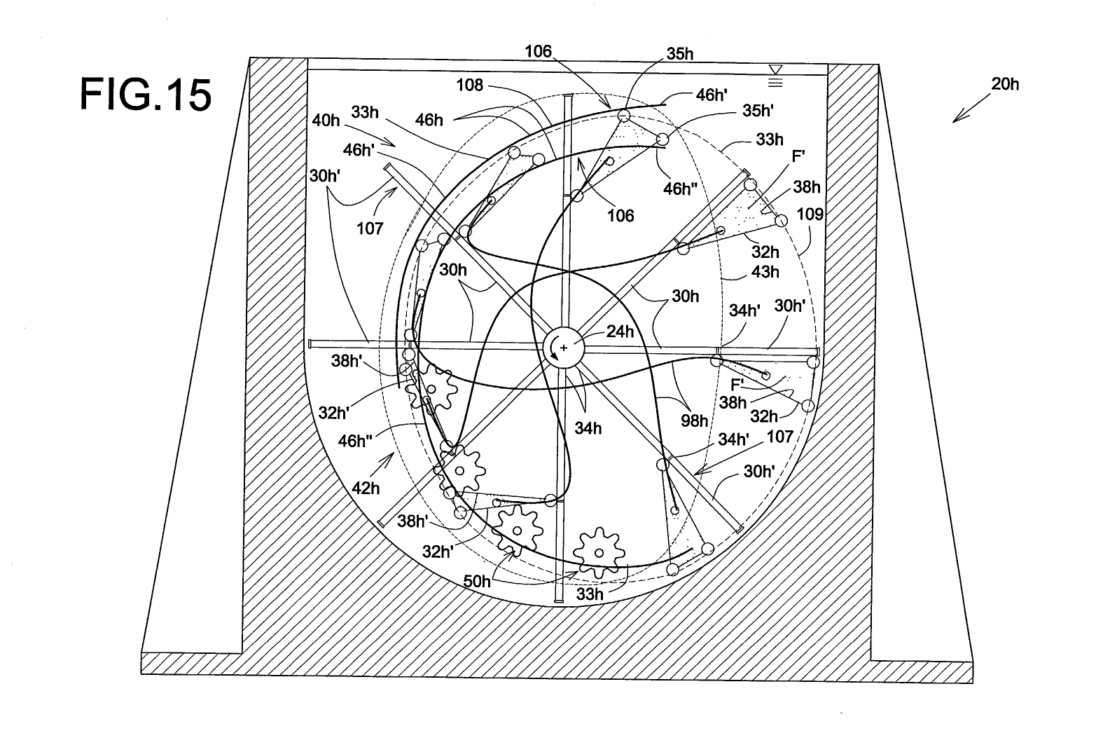

An eighth embodiment 20h of a gravity-actuated motor apparatus according to the present invention as illustrated in FIG. 15 has its floats 32h,32h′ pivotally connected to the support second ends 34h′ of the supports 30h about a respective axis parallel to the shaft 24h. The support first ends 34h are fixed relative to the shaft 24h. The track member 40h, preferably a rail 46h similar to the rail 46 of FIG. 12, is modified accordingly to force the pivoting of the floats 32h,32h′ relative to the support second ends 34h and the shaft 24h.

As opposed to the embodiment 20c of FIG. 10 wherein each weight 32c,32c′ forms a closed shell 38,38′ partially filled with a liquid, the floats 32h,32h′ of the embodiment 20h are generally inflatable closed shells 38h,38h′ partially filled with a fluid F′ between a deflated configuration and an inflated configuration. The fluid F′ is preferably a gas-type fluid such as air or the like, of the first density D. The apparatus 20h also includes a plurality of fluid channeling means 98h for channeling the fluid F′ between one of the shells 38h and a preferably diametrically opposed shell 38h′. The track member 40h includes a shell deflating means 106 for deflating one of the shells 38h at a time along a deflating portion 108 of the closed path 33h so as to force the fluid F′ to flow through the fluid channeling means 98h to the opposed shell 38h′ entering a raising portion 109 of the closed path 33h, so as to deflate the lowering float 32h and inflate the opposed raising float 32h′ to decrease and increase their buoyancy force, respectively.

Each float 32h,32h′ preferably includes two rods 35h,35h′ adapted to engage a rail external part 46h′ and a rail internal part 46h, respectively. The entering portions of the rail external 46h′ and internal 46h parts substantially define the deflating portion 108 of the closed path 33h.

In order to retain the floats 32h,32h′ as far as possible from the shaft axis A in a substantially radially and outwardly extended position rerlative to the support second end 34h′, especially within the raising portion 109 of the closed path 33h, each support second end 34h′ includes a weight abutment means 107, preferably a support extension 30h′ rigidly extending radially and outwardly therefrom so as to abuttingly receive the float 32h,32h′ thereon, when in the inflated configuration.

Although any suitable embodiment could be considered without departing from the scope of the present invention, each channel means 98h is preferably made out of a flexible tubing connected to two opposed shells 38h,38h′ and preferably running adjacent the pivot link of each float 32h,32h′. The flexible tubing is in fluid communication with the shells 38h,38h′ of the floats 32h,32h′ along the support 30h.

The cogwheels 62 of the speed adjusting means 50h of the active guiding means 42h supported by the support structure 43h preferably releasably engage the rods 35h,35h′ to lower the floats 32h,32h′ and properly position them to ensure their abutment contact with the support extensions 30h′ during their transition to the raising portion 109 of the closed path 33h.

In the following embodiments of the present invention, the illustrated weights 32,32′ are generally heavy, of a relatively high density D material.

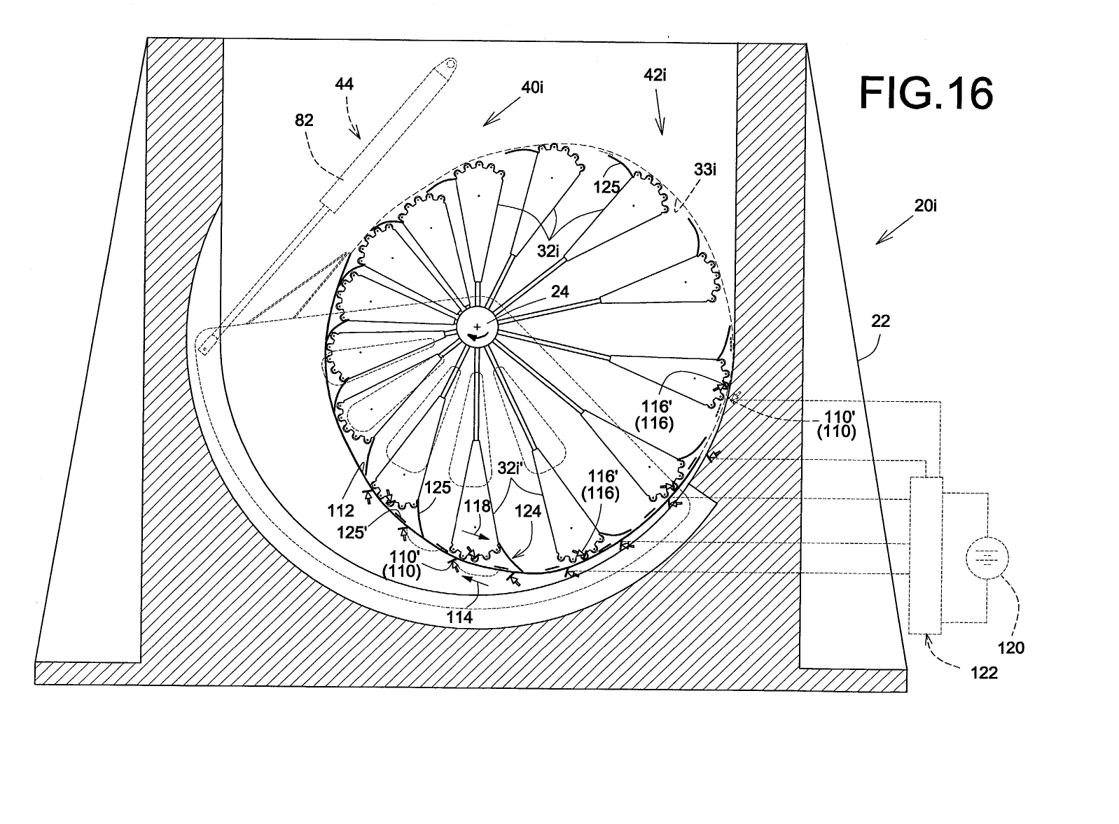

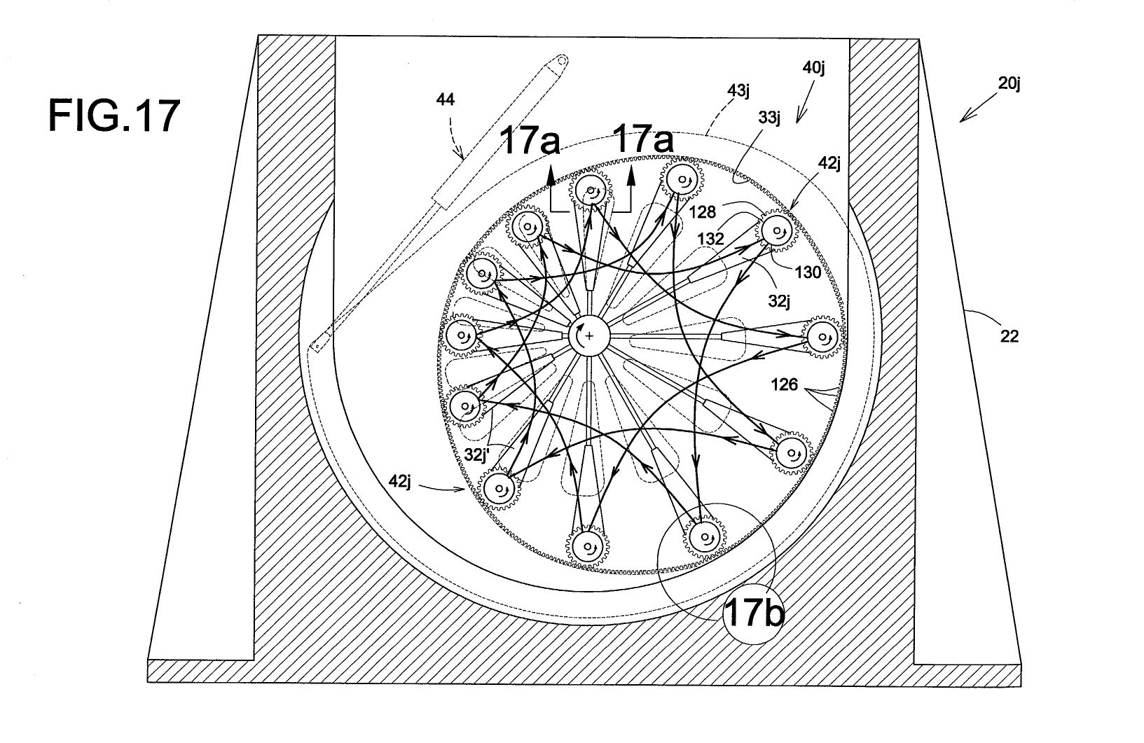

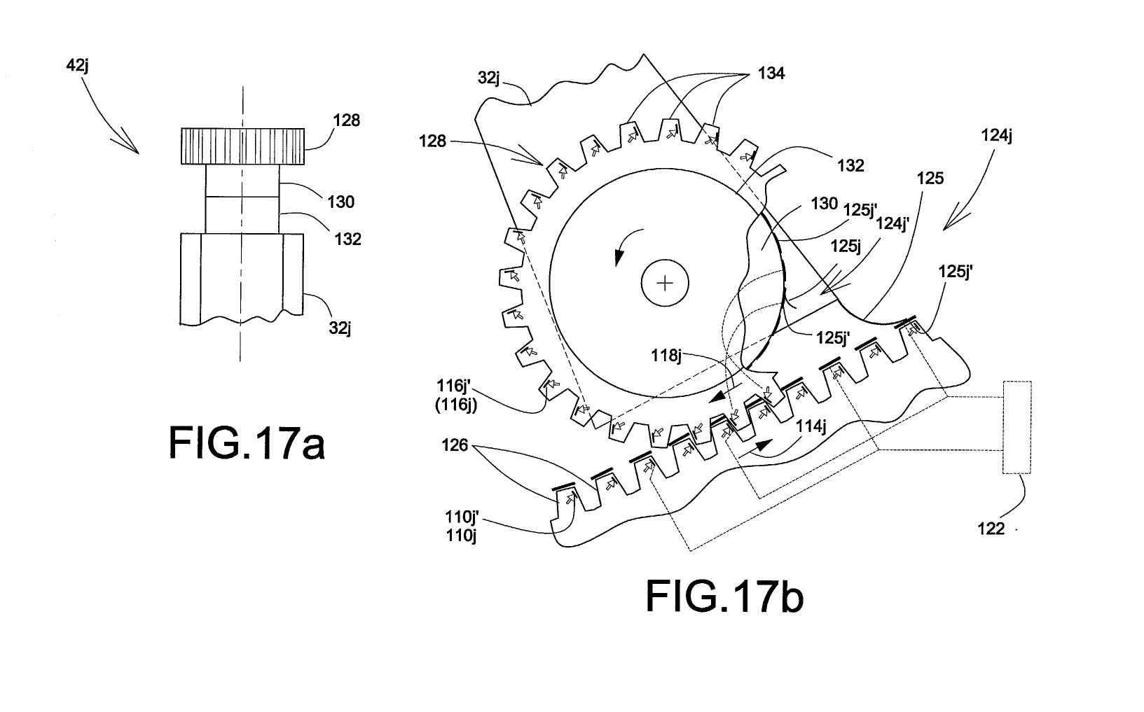

Conveniently, as schematically illustrated in FIG. 16, the active guiding means 42i of a ninth embodiment 20i of a gravity-actuated motor apparatus according to the present invention substantially similar to the embodiment 20 of FIGS. 1 to 7 includes a plurality of fixed magnets 110 mounted on the track 40i. The fixed magnets 110 are substantially equally spaced apart from each other along preferably a magnet portion 112 of the closed path 33i. The magnet portion 112 is preferably extended to the entire closed path 33i as illustrated by the additional fixed magnets 110 shown in the upper portion of the apparatus 20i in dotted lines in FIG. 17 described below, in which case the support structure 43i encompasses the closed path 33i.

As it is well known in the art magnets have a maximal magnetic field level in a specific maximal field direction and a magnetic field that gradually reduces with an increasing angle relative to that maximal field direction. Accordingly, each fixed magnet 110 is preferably oriented so as to provide a maximal fixed magnetic field in a first substantially circumferential direction 114 of the closed path 33i. All the maximal fixed magnetic fields are of a same first electrical polarity.

The active guiding means 42i also includes a mobile magnet 116 mounted on each weight 32i,32i′. Each mobile magnet 116 is oriented so as to provide a maximal mobile magnetic field in a second substantially circumferential direction 118 of the closed path 33i when the weights 32i are adjacent the magnet portion 112 of the closed path 33i. The second circumferential direction 118 is substantially in opposite direction relative to the first circumferential direction 114. All of the mobile magnetic fields are preferably of the same first electrical polarity as the fixed magnetic fields with the first circumferential direction 114 being the direction of circumferential displacement of the weights 32i,32i′ relative to the closed path 33i. Accordingly, the mobile magnets 116 magnetically interact with the fixed magnets 110 by magnetically repulsing each other to induce displacement of the weights 32i,32i′ relative to the track 40i along the closed path 33i.

Alternatively, if the second circumferential direction 118 is the direction of circumferential displacement of the weights 32i,32i′ relative to the closed path 33i, all of the mobile magnetic fields are of the opposite alternate 30 electrical polarity of the first electrical polarity of the fixed magnetic fields so that the mobile magnets 116 magnetically interact with the fixed magnets 110 by magnetically attracting each other to induce displacement of the weights 32i,32i′ relative to the track 40i along the closed path 33i.

Conveniently, at least a portion, preferably all, of the fixed magnets 110 are fixed electro-magnets 110′. Obviously, when only a fraction of the fixed magnets 110 are fixed electro-magnets 110′, the latter are substantially equally spaced apart from each other along the magnet portion 112 of the closed path 33i so as to be uniformly distributed therealong.

An electrical power source 120 is then connected to the fixed electromagnets 110′. The power source 120 is either directly coming from the generator G or from an external source. Also, an electromagnet controlling means 122 controls the selective powering of the fixed electromagnets 110′ when the mobile magnets 116 of the weights 32i,32i′ successively get into proximity to the fixed electromagnets 110′.

Although slightly more complex to realize, similarly, at least a portion, preferably all, of the mobile magnets 116 are mobile electromagnets 116′ also connected to electrical power source 120 and selectively controlled for powering by the electromagnet controlling means 122 when they 116′ successively get into proximity to the fixed magnets 110 and the fixed electromagnets 110′.

The electromagnet controlling means 122 includes switches 124 mounted on the track 40i at specific locations therealong for their selective momentary activation by the successive weights 32i,32i′ being displaced along their closed path 33i. Each switch 124 is electrically connected to a respective 31 one of the fixed electromagnets 110′ and/or mobile electromagnets 116′ for their timely operation, such that a respective fixed electromagnet 110′ and/or mobile electromagnet 116′ is momentarily powered when in proximity to a corresponding mobile magnet 116 or mobile electromagnet 116′ and/or a corresponding fixed magnet 110 or fixed electromagnet 110′, respectively.

Each switch 124 typically includes a flap-like spring connector 125 mounted on each weight 32i,32i′ to resiliently slide on the auxiliary track 78 and/or the peripheral wall 76 having thereon two parallel complementary switch tracks 125′ and establish the momentary electrical contact therebetween. The flap-like spring connectors 125 and the switch tracks 125′ are only represented on FIG. 16. Solely for clarity purpose, only a few switches 124 for the fixed electromagnets 110′ and mobile electromagnets 116′ are illustrated on FIG. 16, although it is to be understood that there should be one for each one of them 10′, 116′.

Conveniently, as schematically illustrated in FIG. 17, the active guiding means 42j of a tenth embodiment 20j of a gravity-actuated motor apparatus according to the present invention includes a plurality of guiding teeth 126 mounted on auxiliary track 78 of the track 40j that typically substantially extends all the way along the closed path 33j. The guiding teeth 126 are substantially equally spaced apart from each other along at least a portion, preferably all, of the closed path 33j of the weights 32j,32j′. A pinion 128 is rotatably mounted on each weight 32j,32j′ and has its pinion teeth 134 releasably meshing with the guiding teeth 126. Each pinion 128 rotates about a respective axis substantially parallel to the shaft axis A.

As shown in FIG. 17a, a pinion hydraulic pump mechanism 130 and a pinion hydraulic motor 132 are connected to each pinion 128. The pinion hydraulic pump mechanism 130 of each pinion 128 hydraulically interconnects with a corresponding hydraulic motor 132 of another pinion 128. In other words, the pinion hydraulic pump mechanism 130 connected to the pinion 128 of a first weight 32j is activated the pinion 128 engaging the guiding teeth 126 when the weight 32j falls under gravity. This pinion hydraulic pump mechanism 130 hydraulically actuates the corresponding pinion hydraulic motor 132 of a second weight 32j′ connected to the corresponding pinion 128 also engaging the guiding teeth 126 so as to raise the second weight 32j′ against gravity therealong.

Obviously, the pinion hydraulic pump mechanism 130 of the first weight 32j is interconnected to the pinion hydraulic motor 132 of a third weight 32j, and so on, so as to form a plurality of groups of hydraulically interconnected weights 32j,32j′. Each group preferably forms a closed hydraulic loop with all pinion hydraulic pump mechanisms 130 and pinion hydraulic motors 132 interconnected in series. Preferably, the second weight 32j′ with the pinion hydraulic motor 132 is substantially located about ninety (90) to one hundred and twenty (120) degrees ahead of the first weight 32j with the pinion hydraulic pump mechanism 130 interconnected thereto (for groups of four (4) or three (3) weights 32j,32j′, respectively), such that the first weight 32j falls under gravity and is able to generate power when the second weight 32j′ needs some help to be raised against gravity.

In order to help the power generated by the torque of the weights 32j,32j′ around the shaft 24, similarly to the apparatus 20i described hereinabove, a plurality of fixed magnets 110j and/or fixed electromagnets 110j′ are mounted on at least a portion, preferably all, of the guiding teeth 126. Each fixed magnet 110j and fixed electromagnet 110j′ is oriented so as to provide a maximal fixed magnetic field in a first substantially circumferential direction 114j of the closed path 33j and all of the fixed magnetic fields are of a same first electrical polarity.

Similarly, a mobile magnet 116j and/or mobile electromagnet 116j′ is mounted on each pinion teeth 134. Each mobile magnet 116j and mobile electromagnet 116j′ is oriented so as to provide a maximal mobile magnetic field in a second substantially circumferential direction 118j of the closed path 33j when the weights 32j,32j′ are adjacent the closed path 33j, as illustrated in FIG. 17b. The second circumferential direction 118j is substantially in opposite direction relative to the first circumferential direction 114j. All of the mobile magnetic fields are preferably of a same first electrical polarity as the fixed magnetic fields with the first circumferential direction 114j being opposite to the direction of circumferential displacement of the weights 32j,32j′ relative to the closed path 33j. Accordingly, the mobile magnets 116j and mobile electromagnets 116j′ magnetically interact with the fixed magnets 110j and the fixed electromagnets 110j′ by magnetically repulsing each other to induce displacement of the weights 32j,32j′ relative to the track 40j along the closed path 33j.

Although the fixed 110j′ and the mobile 116j′ electromagnets are only shown on a small portion of the closed path 33j on FIG. 17b, it is to be understood that they are present along almost the entire closed path 33j.

Alternatively, if the second circumferential direction 118j is the opposite to direction of circumferential displacement of the weights 32j,32j′ relative to the closed path 33j, all of the mobile magnetic fields are of the opposite alternate electrical polarity of the first electrical polarity of the fixed magnetic fields so that the mobile magnets 116j and the mobile electro-magnets 116j′ magnetically interact with the fixed magnets 110j and the fixed electromagnets 110j′ by magnetically attracting each other to induce displacement of the weights 32j,32j′ relative to the track 40j along the closed path 33j.

An electrical power source 120j is connected to the fixed electromagnets 110j′ and the mobile electro-magnets 116j′. Also, an electromagnet controlling means 122j controls the selective powering of the fixed electromagnets 110j′ and the mobile electromagnets 116j′ of a pinion 128 when the mobile magnets 116j and mobile electromagnets 116j′ of the pinion 128 successively get into proximity to the fixed magnets 110j and fixed electromagnets 110j′. Furthermore, the electromagnet controlling means 122j also controls the selective powering of the mobile electro-magnets 116j′ within a pinion 128.

Typically, the first 122j and second 122j′ electromagnet controlling means 122j includes first switches 124j mounted on the track 40j and preferably second switches 124j′ mounted on the weights 32j,32j′, at specific locations therealong for their selective momentary activation by the successive weights 32j,32j′ and pinions 128 being displaced along their closed path 33i and rotated, respectively.

Although not illustrated, only the first switches 124j could be used so as to replace the second switches 124j′ and simultaneously perform their function.

Each first switch 124j is electrically connected to a respective one of the fixed electromagnets 110j′ and/or pinions 128 for their timely operation, such that a respective fixed electromagnet 110j′ and/or pinion 128 is momentarily powered when in proximity to a corresponding mobile magnet 116j or mobile electromagnet 116j′ of a pinion 128 and/or a corresponding fixed magnet 110j or fixed electromagnet 110j′, respectively.

Similarly, each second switch 124j′ is electrically connected to a respective one of the mobile electromagnets 116j′ of a same pinion 128 for their timely operation, such that a respective mobile electromagnet 116j′ is momentarily powered when in proximity to a corresponding fixed magnet 110j or fixed electromagnet 110j′, simultaneously, during the activation of the corresponding first switch 124j.

The first switches 124j essentially operate similarly to the switches 124 of the embodiment 20i of FIG. 16, with the flap-like spring connectors 125 mounted on the weights 32j,32j′ for resilient interaction with the complementary switch tracks 125′ mounted on the track 40j. Similarly, the second switches 124j′ include the flap-like spring connectors 125j mounted on the weights 32j,32j′ to resiliently interact with the complementary switch tracks 125j′ mounted on the pinions 128.

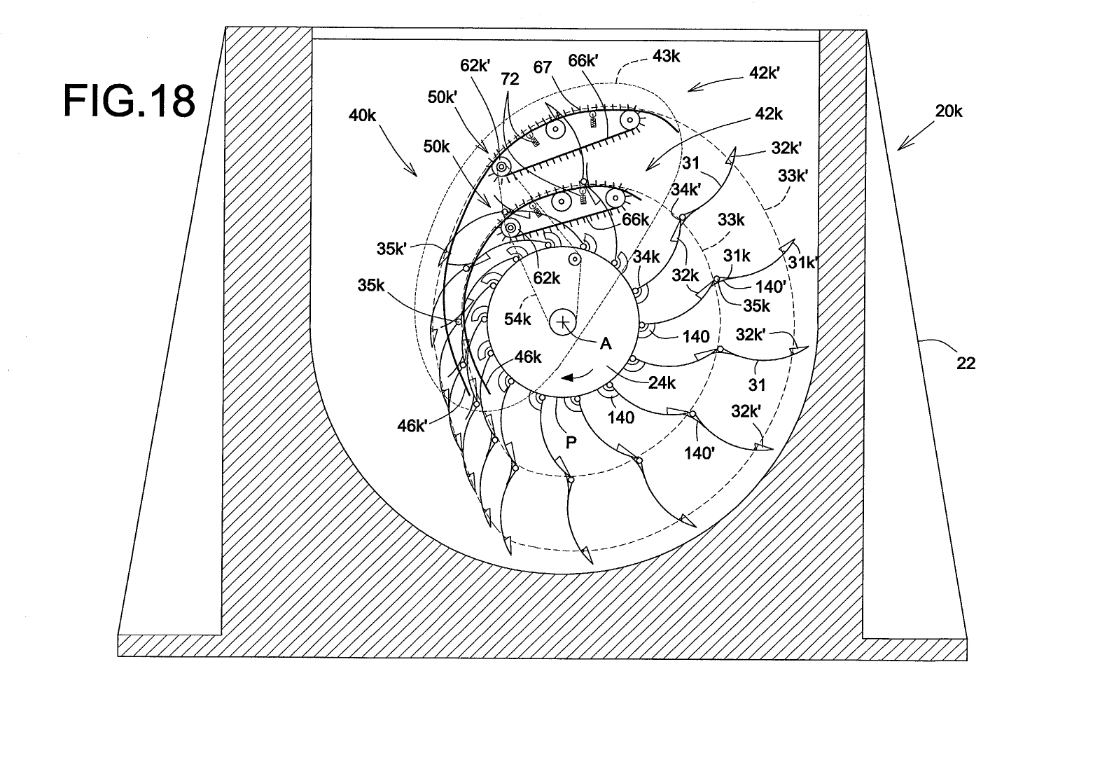

Conveniently, as schematically illustrated in FIG. 18, the shaft 24k of an eleventh embodiment 20k of a gravity-actuated motor apparatus according to the present invention defines a generally circular periphery P.

Each support 30k defines a support first end 34k and an opposed support second end 34k′. Each support first end 34k preferably pivotally connects to the shaft periphery P about a respective axis substantially parallel to the shaft axis A so that the support 30k pivots relative to the shaft periphery P between a support retracted position (shown in the left-hand-side of FIG. 18) with the support 30k extending in a generally circumferential configuration relative to the shaft 24k and a support extended position (shown in the right-hand-side of FIG. 18) with the support 30k extending in a generally radially outwardly configuration relative to the shaft 24k. The supports 30k are substantially circumferentially equally spaced apart from each other along the shaft periphery P and of generally concave shape in order to substantially assume a portion of the shaft periphery P when in support retracted position.

A weight 32k preferably mounts on each support second end 34k′ to radially move relative to the shaft 24k along a closed path 33k, so as to provide variable torque thereto; the variable torque being larger the closer the support 30k is to its support extended position.

The track 40k is releasably engaged on an internal rail 46k by the weights 32k and guides the radial displacement of the weights 32k relative to the shaft 24k along at least a portion of the closed path 33k. The track 40k includes a speed adjusting means 50k of an active guiding means 42k preferably connected to the shaft 24k via the chain member 54k and cogwheel 62k to actively guide the weights 32k along the tracking portion 41k of the closed path 33k.

The speed adjusting means 50k of the active guiding means 42k is similar to those described hereinabove and preferably includes a flexible chain 66k with substantially transversal flaps 67. The flexible chain 66k is driven by the cogwheel 62k and is engaged by rods 35k extending substantially outwardly and axially from the weights 32k to generally successively displaces the different supports 30k from their support retracted configuration to their support extended configuration, as shown in FIG. 18.

A plurality of support abutting means 140 for abuttingly receiving the support first ends 34k thereon while retaining the supports 30k in their support extended position against gravity are preferably located on the shaft 24k adjacent the support first ends 34k.

As shown in FIG. 18, each support second end 34k′ substantially abuts an adjacent support 30k adjacent the shaft periphery P when the support 30k is in its support retracted position under gravity.

Preferably, each support 30k includes an elongated support extension 31. Each support extension 31 defines an extension first end 31k and an opposed extension second end 31k′. Each extension first end 31k pivotally connects to the support second end 34k′ about a respective axis substantially parallel to the shaft axis A so that the support extension 31 pivots relative to the support second end 34k′ between a support extension retracted position (shown in the left-hand-side of FIG. 18) with the support extension 31 extending in a generally circumferential configuration relative to the shaft 24k and a support extension extended position (shown in the right-hand-side of FIG. 18) with the support extension 31 extending in a generally radially outwardly configuration relative to the support second end 34k′ and the shaft 24k.

A second weight 32k′ mounts on each support extension second end 31 k′ to radially move relative to the shaft 24 along a second closed path 33k′ so as to provide variable torque thereto; the variable torque being larger the closer the support extension 31 is to its support extension extended position.

The track 40k is also releasably engaged on an external rail 46k′ by the second weights 32k′ and guides the radial displacement of the second weights 32k′ relative to the shaft 24k along at least a portion of the second closed path 33k′. The track 40k includes a second speed adjusting means 50k′ of a second active guiding means 42k′ preferably connected to the shaft 24k via the chain member 54k and cogwheel 62k′ to actively guide the second weights 32k′ along the tracking portion 41k′ of the second closed path 33k′.

Consequently, a plurality of second support abutting means 140′ for abuttingly receiving the support extension first end 31k thereon to retain the support extension 31 in its support extension extended position against gravity are preferably located on the support second ends 34k′ adjacent the support extension first ends 31k.

Similarly, as shown in FIG. 18, each support extension second ends 31k′ substantially abuts an adjacent support extension 31 adjacent the shaft periphery P when the support extension 31 is in its support extension retracted position under gravity.

Although not described hereinabove and not illustrated in the accompanying drawings, the apparatuses 20 to 20k of the present invention may require at least one brake mechanism to stop the apparatus either under normal conditions or for emergency. Furthermore, an external source of power is required to start the apparatus, depending on its physical dimensions. Similarly, a speed control mechanism could be required to preferably automatically control the rotational speed of the apparatus.

Although the present gravity-actuated motor apparatus has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A gravity-actuated motor apparatus (20) for connecting to a power generator (G), said apparatus comprising:
a frame (22) defining an enclosure (23);
a generally horizontal shaft (24) defining a shaft axis (A), said shaft (24) being freely rotatably supported by said frame (22) for connection to said power generator(G);
a plurality of elongated supports (30) extending substantially radially away from and connecting to said shaft (24), said supports (30) being substantially circumferentially equally spaced apart from each other;
at least one weight member (32) connecting to each one of said supports (30), said weight members (32) have a first density (D) and radially move relative to said shaft (24) along a closed path (33), thereby providing variable torque thereto;
a track member (40) guiding displacement of said weight members (32) relative to said shaft (24) along at least a tracking portion (41) of said closed path (33), said track member (40) being releasably engaged by said weight members (32);
an active guiding means (42) for actively guiding said weight members (32) along said tracking portion (41) of said closed path (33), said active guiding means (42) mounting on said track member (40); and
a soaking medium (26) filling said enclosure (23) to soak said shaft (24), supports (30) and weight members (32) therein, said soaking medium (26) having a second density (D′); whereby a difference between said first (D) and second (D′) densities induces displacement of said weight members (32) relative to said soaking medium (26) within said enclosure (23) under gravity so as to rotate said shaft (24) connected to said power generator (G).

2. The apparatus (20) of claim 1, including a track member positioning means (44) for positioning said track member (40) relative to said shaft (24), said track member positioning means (44) defining a pivotal axis (B) parallel to the shaft axis (A), said track member positioning means (44) pivoting said track member (40) about said pivotal axis (B).

3. The apparatus (20) of claim 1, wherein said active guiding means (42) includes at least one speed adjusting means (50) for adjusting the speed of said active guiding means (42) to the varying speed of said weight members (32) along said tracking portion (41) of said closed path (33), said speed adjusting means (50) successively guiding displacement of one of said weight members (32) at a time.

4. The apparatus (20) of claim 3, wherein said at least one speed adjusting means (50) includes a weight member engaging means (52) for releasably engaging said weight members (32) to said speed adjusting means (50b), a hydraulic motor (94) driving said weight member engaging means (52), and a hydraulic fluid pump (96) connecting to said shaft (24) and feeding said hydraulic motor (94).

5. The apparatus (20) of claim 3, wherein said at least one speed adjusting means (50) includes a weight member engaging means (52) for releasably engaging said weight members (32) to said speed adjusting means (50), a chain member (54) connecting to said shaft (24), and a torsion spring connecting member (56) for circumferentially and springingly connecting said weight member engaging means (52) to said chain member (54).

6. The apparatus (20) of claim 5, wherein each of said weight members (32) includes a complementary track member engaging means (60) for releasably engaging said weight member (32) to said weight member engaging means (52), said weight member engaging means (52) includes a cogwheel (62) engaging said complementary track member engaging means (60).

7. The apparatus (20) of claim 6, wherein said weight member engaging means (52) includes a flexible chain (66) driven by cogwheel gear (62) and engaging said complementary track member engaging means (60).

8. The apparatus (20) of claim 7, wherein said weight member engaging means (52) further includes a flexible chain retaining means (72) for retaining said flexible chain (66) in engagement contact with said complementary track member engaging means (60), said flexible chain retaining means (72) mounting on said track member (40).

9. The apparatus (20) of claim 8, wherein said flexible chain retaining means (72) includes at least one spring biased roller (74) resiliently biased to retain said flexible chain (66) in engagement contact with said complementary track member engaging means (60), said flexible chain (66) rollingly contacting said spring biased roller (74).

10. The apparatus (20) of claim 2, wherein said pivotal axis (B) is co-linear with said shaft axis (A).

11. The apparatus (20f) of claim 10, wherein said track member (40f) including a rail (46), each weight member (32f) includes at least one rod (35) extending therefrom and slidably engages said rail (46).

12. The apparatus (20) of claim 2, wherein said track member (40) being symmetrical relative to a symmetrical axis (S) radially intersecting said shaft (24) to allow for operation of said apparatus (20) in both rotational directions about said shaft axis (A).

13. The apparatus (20) of claim 1, wherein said first density (D) being larger than said second density (D′); whereby rotation of said shaft (24) being induced by the torque provided by said weight members (32) under gravity.

14. The apparatus (20) of claim 1, wherein said first density (D) being smaller than said second density (D′); whereby rotation of said shaft (24) being induced by the torque provided by said weight members (32) raising under buoyancy.

15. The apparatus (20) of claim 13, wherein each of said supports (30) defining a support first end (34) and an opposed support second end (34′), said supports (30) being axially spaced apart from each other along said shaft (24) and freely radially sliding relative to said shaft (24) between said support first (34) and second (34′) ends, a first (32) and a second (32′) of said weight members being fixedly connected to said support first (34) and second (34′) ends, respectively, said track member (40) radially displacing said weight members (32,32′) and said supports (30) relative to said shaft (24).

16. The apparatus (20d) of claim 13, wherein each of said supports (30d) defining a support first end (34d) and an opposed support second end (34d′), said support first end (34d) attaching to said shaft (24d), said weight members (32d) longitudinally sliding relative to said supports (30d) between said support first (34d) and second (34d′) ends, said track member (40d) radially displacing said weight members (32d) relative to said supports (30d) and said shaft (24d).

17. The apparatus (20c) of claim 15, wherein each of said weight members (32c,32c′) forming a closed shell (38,38′) defining a cavity (39,39′) therein, each of said cavity (39,39′) being partially filled with a fluid (F), said apparatus (20c) including a plurality of fluid channeling means (98) for channeling said fluid (F) between one of said cavities (39) and an opposed of said cavities (39′), thereby allowing for said fluid (F) to freely flow therein between said opposed cavities (39,39′).

18. The apparatus (20c) of claim 17, wherein each of said supports (30c) defines a through bore (100) longitudinally extending between said support first (34c) and second (34c′) ends, said through bore (100) being in fluid communication with said cavities (39,39′) of said weight members (32c,32c′) of said support (30c) to form one of said fluid channeling means (89) therebetween.

19. The apparatus (20c) of claim 18, wherein said fluid (F) being of said first density (D), said fluid (F) freely flowing along said through bores (100) from one (39) of the cavities to the opposed one (39′) under gravity.

20. The apparatus (20e) of claim 14, wherein each of said supports (30e) defining a support first end (34e) and an opposed support second end (34e′), said supports (30e) being axially spaced apart from each other along said shaft (24) and freely radially sliding relative to said shaft (24) between said support first (34e) and second (34e′) ends, a first (32e) and a second (32e′) of said weight members being fixedly connected to said support first (34e) and second (34e′) ends, respectively, said track member (40e) radially displacing said weight members (32e,32e′) and said supports (30e) relative to said shaft (24).

21. The apparatus (20g) of claim 14, wherein each of said supports (30g) defining a support first end (34g) and an opposed support second end (34g′), said support first end (34g) attaching to said shaft (24g), said weight members (32g) longitudinally sliding relative to said supports (30g) between said support first (34g) and second (34g′) ends, said track member (40g) radially displacing said weight members (32g) relative to said supports (30g) and said shaft (24g).

22. The apparatus (20h) of claim 14, wherein each of said weight members (32h,32h′) forming a closed shell (38h,38h′) being generally inflatable with a fluid (F′) between a deflated configuration and an inflated configuration, said apparatus (20h) including a plurality of fluid channeling means (98h) for channeling said fluid (F′) between one of said shells (38h) and an opposed of said shells (38h′), said track member including a shell deflating means (106) for deflating one of said shells (38h,38h′) at a time along a deflating portion (108) of said closed path (33h) so as to force said fluid (F′) to flow through said fluid channeling means (98h) between said opposed shells (38h,38h′).

23. The apparatus (20h) of claim 14, wherein each of said supports (30h) defining a support first end (34h) and an opposed support second end (34h′), said support first end (34h) attaching to said shaft (24h), said weight members (32h,32h′) pivotally connecting to said support second ends (34h′) about a respective axis substantially parallel to said shaft (24h), said track member (40h) pivotally and radially displacing said weight members (32h,32h′) relative to said supports (30h) and said shaft (24h), each of said support second end (34h′) including a weight abutment means (107) for retaining said weight member (32h,32h′) in a substantially radially and outwardly extending position relative to said support (30h) with said weight member (32h,32h′) being in a raising portion (109) of said closed path (33h).

24. The apparatus (20h) of claim 23, wherein said weight abutment means (107) is a support extension (30h′) rigidly extending radially and outwardly from said support second end (34h′) so as to abuttingly receive said weight member (32h,32h′) thereon.

25. The apparatus (20h) of claim 23, wherein each of said weight members (32h,32h′) forming a closed shell (38h,38h′) being generally inflatable with a fluid (F′) between a deflated configuration and an inflated configuration, said apparatus (20h) including a plurality of fluid channeling means (98h) for channeling said fluid (F′) between one of said shells (38h) and an opposed of said shells (38h′), said track member including a shell deflating means (106) for deflating one of said shells (38h,38h′) at a time along a deflating portion (108) of said closed path (33h) so as to force said fluid (F′) to flow through said fluid channeling means (98h) between said opposed shells (38h,38h′), each of said weight abutment means (107) retains said weight member (32h,32h′) in a substantially radially and outwardly extending position relative to said support (30h) with said weight member (32h,32h′) being in a raising portion (109) of said closed path (33h) in said inflated configuration.

26. The apparatus (20h) of claim 25, wherein each of said supports (30h) defines a through bore (100h) extending between said support first (34h) and second (34h′) ends, said through bore (100h) being in fluid communication 48 with said shells (38h,38h′) of said weight members (32h,32h′) of said support (30h) to form one of said fluid channeling means (98h) therebetween.

27. The apparatus (20h) of claim 26, wherein said fluid (F′) being of said first density (D), said fluid (F′) flowing along said through bores (100h) from one (38h) of the shells to the opposed one (38h′) under operation of shell deflating means (106).

28. The apparatus (20) of claim 15, wherein said shaft (24) defines a plurality of through bores (84), said through bores (84) being diametrically oriented relative to said shaft (24), each of said through bores (84) defining a bore axis (86) and a bore inner surface (88), each of said through bores (84) slidably receiving one of said supports (30) therethrough.

29. The apparatus (20) of claim 28, wherein said shaft (24) includes a plurality of roller bearings (90) for rollably supporting each of said supports (30) inside said through bores (84), each of said roller bearings movably mounting on said shaft (24) for radial displacement relative thereto between a bearing first position wherein said support (30) is substantially longitudinally aligned with said through bore axis (86) and a bearing second position wherein said support (30) is off-aligned from said through bore axis (86) without abuttingly contacting said bore inner surface (88), and a bearing biasing means (92) for biasing said roller bearings (90) in said bearing first position.

30. The apparatus (20j) of claim 15, wherein said active guiding means (42j) includes:
a plurality of guiding teeth (126) mounted on said track member (40j), said guiding teeth (126) being substantially equally spaced apart from each other along at least a portion of said closed path (33j);
a pinion (128) rotatably mounted on each of said weight members (32j,32j′) about an axis substantially parallel to said shaft axis (A) for releasably meshing with said guiding teeth (126);
a pinion hydraulic pump mechanism (130) connected to said pinion (128);
a pinion hydraulic motor (132) connected to said pinion (128);
said pinion hydraulic pump mechanism (130) of each of said pinions (128) hydraulically interconnecting with a corresponding of said pinion hydraulic motors (132) of another of said pinions (128) so as to have said pinion hydraulic pump mechanism (130) activated by said pinion (128) of a first of said weight members (32j) engaging said guiding teeth (126) under gravity hydraulically actuating said corresponding pinion hydraulic motor (132) of a second of said weight members (32j′) to activate said corresponding pinion (128) also engaging said guiding teeth (126) to actively raise said second weight member (32j′) against gravity.

31. The apparatus (20i) of claim 15, wherein said active guiding means (42i) includes:
a plurality of fixed magnets (110) mounted on said track member (40i) and being substantially equally spaced apart from each other along a magnet portion (112) of said closed path (33i), each of said fixed magnets (110) being oriented so as to provide a maximal fixed magnetic field in a first substantially circumferential direction (114) of said closed path (33i), all of said fixed magnetic fields being of a first electrical polarity;
a mobile magnet (116) mounted on each of said weight members (32i,32i′), said mobile magnet (116) being oriented so as to provide a maximal mobile magnetic field in a second substantially circumferential direction (118) of said closed path (33i) when said weight members (32i,32i′) are adjacent said magnet portion (112) of said closed path (33i), said second circumferential direction (118) being substantially in opposite direction relative to said first circumferential direction (114), all of said mobile magnetic fields being of a second electrical polarity, said mobile magnet (116) magnetically interacting with said fixed magnets (110) to induce displacement of said weight members (32i,32i′) relative to said track member (40i) along said closed path (33i).

32. The apparatus (20i) of claim 31, wherein at least a portion of said fixed magnets (110) are fixed electro-magnets (110i), said fixed electromagnets (110i) being substantially equally spaced apart from each other along said magnet portion (112) of said closed path (33i), said active guiding means (42i) further including:
an electrical power source (120) connected to said fixed electromagnets (110i);
an electro-magnet controlling means (122) for controlling the selective powering of said fixed electro-magnets (110i) when said mobile magnet (116) of said weight members (32i,32i′) successively get into proximity to said fixed electro-magnets (110i), each of said fixed electro-magnets (110i) providing a maximal fixed electromagnetic field in said first circumferential direction (114), said fixed electromagnetic fields being of said first electrical polarity.

33. The apparatus (20i) of claim 32, wherein at least a portion of said mobile magnets (116) are mobile electro-magnets (116′), said electrical power source (120) being connected to said mobile electromagnets (116′), said electromagnet controlling means (122) further controlling the selective powering of said mobile electromagnets (116′) when said mobile electro-magnets (116′) of said weight members (32i,32i′) successively get into proximity to said fixed magnets (110) and said fixed electromagnets (110′), each of said mobile electromagnets (116′) providing a mobile maximal electromagnetic field in said second circumferential direction (118), said mobile electromagnetic fields being of said second electrical polarity.

34. The apparatus (20i) of claim 33, wherein said electromagnet controlling means (122) includes switches (124) mounted on said track member (40i), each of said switches (124) being electrically connected to a respective one of said fixed electromagnets (110′) and/or mobile electromagnets (116′) for operation thereof, said switches (124) being selectively momentarily activated by said weight members (32i,32i′) so as to momentarily provide power to said respective fixed electromagnets (110′) and/or mobile electromagnets (116′) when in proximity to a corresponding of said mobile magnets (116) or mobile electromagnets (116′) and/or a corresponding of said fixed magnets (110) or fixed electromagnets (110′), respectively.

35. The apparatus (20i) of claim 31, wherein said first and second electrical polarities being of a common polarity, said first circumferential direction (114) being substantially the direction of said displacement of said weight members (32i,32i′) relative to said closed path (33i), each of said fixed magnets (110) successively magnetically repulsing each of said mobile magnets (116).

36. The apparatus (20i) of claim 31, wherein said first and second electrical polarities being of opposed polarities, said second circumferential direction (118) being substantially the direction of said displacement of said weight members (32i,32i′) relative to said closed path (33i), each of said fixed magnets (110) successively magnetically attracting each of said mobile magnets (116).

37. The apparatus (20j) of claim 30, wherein each of said pinions (128) defining a plurality of pinion teeth (134), said active guiding means (42j) further includes:
a plurality of fixed magnets (110j) mounted on at least a portion of said guiding teeth (126) and being substantially equally spaced apart from each other, each of said fixed magnets (110j) being oriented so as to provide a maximal fixed magnetic field in a first substantially circumferential direction (114j) of said closed path (33j), all of said fixed magnetic fields being of a first electrical polarity;
a mobile magnet (116j) mounted on at least a portion of said pinion teeth (134) of each of said pinions (128), each of said mobile magnets (116j) being oriented so as to provide a maximal mobile magnetic field in a second substantially circumferential direction (118j) of said closed path (33j) when said weight members (32j,32j′) are adjacent said closed path (33j), said second circumferential direction (118j) being substantially in opposite direction relative to said first circumferential direction (114j), all of said mobile magnetic fields being of a second electrical polarity, said mobile magnets (116j) magnetically interacting with said fixed magnets (110j) to induce displacement of said pinions (128) relative to said guiding teeth (126) and said weight members (32j,32j′) relative to said track member (40j) along said closed path (33j).

38. The apparatus (20j) of claim 37, wherein at least a portion of said fixed magnets (110j) are fixed electromagnets (110j′), said fixed electromagnets (110j′) being substantially equally spaced apart from each other along said portion of said closed path (33j), said active guiding means (42j) further including:
an electrical power source (120j) connected to said fixed electromagnets (110j′);
an electromagnet controlling means (122j) for controlling the selective powering of said fixed electromagnets (110j′) when said mobile magnets (116j) of said pinions (128) of said weight members (32j,32j′) successively get into proximity to said fixed electromagnets (110j′), each of said fixed electromagnets (110j′) providing a maximal fixed electromagnetic field in said first circumferential direction, said fixed electromagnetic fields being of said first electrical polarity.

39. The apparatus (20j) of claim 38, wherein at least a portion of said mobile magnets (116j) are mobile electromagnets (116j′), said electrical power source (120j) being connected to said mobile electromagnets (116j′), said electromagnet controlling means (122j) further controlling the selective powering of said mobile electromagnets (116j′) when said mobile electromagnets (116j′) of said pinions (128) of said weight members (32j,32j′) successively get into proximity to said fixed magnets (110j) and said fixed electromagnets (110j′), each of said mobile electromagnets (116j′) providing a mobile maximal electromagnetic field in said second circumferential direction (118j), said mobile electromagnetic fields being of said second electrical polarity.

40. The apparatus (20j) of claim 39, wherein said electromagnet controlling means (122j) includes switches (124j) mounted on said track member (40j);
each of said switches (124j) being electrically connected to a respective one of said fixed electromagnets (110j′) and/or pinions (128) for operation thereof, said switches (124j) being selectively momentarily activated by said pinions (128) so as to momentarily provide power to said respective fixed electromagnets (110j′) and/or mobile electromagnets (116j′) of pinions (128) when in proximity to a corresponding of said mobile magnets (116j) or mobile electromagnets (116j′) of said pinions (128) and/or a corresponding of said fixed magnets (110j) or fixed electromagnets (110j′), respectively.

41. The apparatus (20j) of claim 39, wherein said electromagnet controlling means (122j) includes first switches (124j) mounted on said track member (40j) and second switches (124j′) mounted on said weight members (32j,32j′);
each of said first switches (124j) being electrically connected to a respective one of said fixed electromagnets (110j′) and/or pinions (128) for operation thereof, said first switches (124j) being selectively momentarily activated by said weight members (32j,32j′) so as to momentarily provide power to said respective fixed electro-magnets (110j′) and/or pinions (128) when in proximity to a corresponding of said mobile magnets (116j) or mobile electromagnets (116j′) of said pinions (128) and/or a corresponding of said fixed magnets (110j) or fixed electro-magnets (110j′), respectively;
each of said second switches (124j′) being electrically connected to a respective one of said mobile electromagnets (116j′) of one of said pinions (128) for operation thereof, said second switches (124j′) being selectively momentarily activated by said pinions (128) so as to momentarily provide power to said respective mobile electromagnets (116j′) when in proximity to a corresponding of said fixed magnets (110j) or fixed electromagnets (110j′).

42. The apparatus (20j) of claim 37, wherein said first and second electrical polarities being of a common polarity, said second circumferential direction (114j) being substantially the direction of said displacement of said weight members (32j,32j′) relative to said closed path (33j), each of said fixed magnets (110j) successively magnetically repulsing each of said mobile magnets (116j).

43. The apparatus (20k) of claim 13, wherein said shaft (24k) defining a generally circular periphery (P);
each of said supports (30k) defining a support first end (34k) and an opposed support second end (34k′), said support first end (34k) pivotally connecting to said shaft periphery (P) about a respective axis substantially parallel to said shaft (24k) so that said support (30k) pivots relative to said shaft periphery (P) between a support retracted position with said support (30k) extending in a generally circumferential configuration relative to said shaft (24k) and a support extended position with said support (30k) extending in a generally radially outwardly configuration relative to said shaft (24k), said supports (30k) being substantially circumferentially equally spaced apart from each other along said shaft periphery (P);
one of said weight members (32k) mounting on each of said support second ends (34k′) to radially move relative to said shaft (24k) along a closed path (33k), thereby providing variable torque thereto, said variable torque being larger the closer said support (34k) is to its support extended position.

44. The apparatus (20k) of claim 43, including a plurality of support abutting means (140) located on said shaft (24k) adjacent said support first ends (34k), each of said support abutting means (140) for abuttingly receiving said support first end (34k) thereon to retain said support (30k) in said support extended position against gravity.

45. The apparatus (20k) of claim 44, wherein each of said support second ends (34k′) substantially abuts an adjacent of said supports (30k) adjacent said shaft periphery (P) when said support (30k) is in said support retracted position under gravity.

46. The apparatus (20k) of claim 45, wherein each of said supports (30k) substantially has a concave shape so as to substantially assume a portion of said shaft periphery (P) when in said support retracted configuration.

47. The apparatus (20k) of claim 43, wherein:
each of said supports (30k) includes an elongated support extension (31), said support extension (31) defining an extension first end (31k) and an opposed extension second end (31k′), said extension first end (31k) pivotally connecting to said support second end (34k′) about a respective axis substantially parallel to said shaft (24k) so that said support extension (31) pivots relative to said support second end (34k) between a support extension retracted position with said support extension (31) extending in a generally circumferential configuration relative to said shaft (24k) and a support extension extended position with said support extension (31) extending in a generally radially outwardly configuration relative to said support second end (34k′) and said shaft (24k);
a second weight member (32k′) mounting on each of said support extension second end (31 k′) to radially move relative to said shaft (24k) along a second closed path (33k′), thereby providing variable torque thereto, said variable torque being larger the closer said support extension (31) is to its support extension extended position; and
said track member (40k) being releasably engaged by said second weight members (32k′), said track member (40k) guiding radial displacement of said second weight members (32k′) relative to said shaft (24k) along at least a portion of said second closed path (33k′), said track member (40k) includes a second active guiding means (42k′) for actively guiding said second weight members (32k′) along said portion of said second closed path (33k′), said second active guiding means (42k′) connecting to said shaft (24k).

48. The apparatus (20k) of claim 47, including a plurality of first and second support abutting means (140,140′) located on said shaft (24k) adjacent said support first ends (34k) and on said support second ends (34k′) adjacent said support extension first ends (31k), respectively, each of said first support abutting means (140) for abuttingly receiving said support first end (34k) thereon to retain said support (30k) in said support extended position against gravity, each of said second support abutting means (140′) for abuttingly receiving said support extension first end (31k) thereon to retain said support extension (31) in said support extension extended position against gravity.

49. The apparatus (20k) of claim 48, wherein each of said support second ends (34k′) substantially abuts an adjacent of said supports (30k) adjacent said shaft periphery (P) when said support (30k) is in said support retracted position under gravity, each of said support extension second ends (31k′) substantially abuts an adjacent of said support extensions (31) adjacent said shaft periphery (P) when said support extension (31) is in said support extension retracted position under gravity.

50. The apparatus (20k) of claim 49, wherein each of said supports (30k) and support extensions (31) substantially has a concave shape so as to substantially assume a portion of said shaft periphery (P) when in said support retracted configuration and said extension retracted configuration, respectively.
